(19) United States
(12) Patent Application Publication
(10) Pub. No.: US 2011/0047230 A1
(43) Pub. Date: Feb. 24, 2011

(54) Method / process / procedure to enable: The Heart Beacon Rainbow Force Tracking

(76) Inventor: Steven J. McGee, Oceanport, NJ (US)

Correspondence Address: Steven J. McGee, PO Box 28, Oceanport, NJ, 07757, US

(21) Appl. No.: 12/856,715

(22) Filed: Aug. 16, 2010

Related U.S. Application Data
(63) Continuation-in-part of application No. 11/601,035, filed on Nov. 17, 2006, now abandoned.

(51) Int. Cl. G06F 15/16

(52) U.S. Cl. 709/206; 709/217

(57) ABSTRACT

The Heart Beacon is a method/process/procedure standardizing spontaneous reorganization converting military adhoc organizational mobility techniques. Net effects are enabled by periodic net management router updates via heartbeat messages followed by router and beacon protocol broadcast of node hop count changes emulating geospatial threshold radius and precedent conditions changes represented by audible tones/vibratory levels in the grid/cloud. A single, synchronized, unified event/alert trigger is achieved by instantiating a single XML schema described by child schema's, data islands/NIEM payloads linking disparate communities. Leader intent is emulated via mission thread/business logic representing medical triage, alert/event evacuation and alternate routing within adjustable geospatial zones. Temporally synchronous, statistically predictable data harvesting cycles sync seed clouds enhancing network forensics as shared fee for services.

### CROSS-REFERENCE TO RELATED APPLICATIONS

This application is a continuation-in-part application of U.S. patent application Ser. No. 11/601,035, filed 17 Nov. 2006, the contents of which are hereby incorporated by reference herein. U.S. patent application Ser. No. 11/601,035, filed 17 Nov. 2006 claims the benefit of U.S. patent application Ser. No. 10/709,358, filed 29 Apr. 2004, U.S. patent application Ser. No. 10/708,000, filed 30 Jan. 2004, and U.S. patent application Ser. No. 10/605,144, filed 11 Sep. 2003, the contents of which are hereby incorporated by reference herein.

### INCORPORATION-BY-REFERENCE OF MATERIAL SUBMITTED WITH INVENTION DISCLOSURE DOCUMENT

The following material submitted with Invention Disclosure Document, is incorporated herein by reference.

The Heart Beacon Rainbow Force Tracking Concept Paper

The Heart Beacon Rainbow Force Tracking Presentation in PowerPoint format for the 2010 10^{th} Annual Network Enabled Warfare Conference 25-29 January, Marriot Hotel, Crystal City Va.

The Heart Beacon Brochure for the Network Enabled Warfare Conference

### BACKGROUND OF THE INVENTION

1. Technical Field of the Invention

This invention does not describe how a single situation awareness system FIG. 1 is made nor does it focus on the how it is used FIG. 1a since situation awareness systems are in common use. The situational awareness system shown is the basis of the invention's reference framework FIGS. 1a, 1b, 2 that this intellectual property protection request is based. Making yet another situational awareness system is counterproductive and exacerbates the very issue this invention intends to resolve—deriving the single, authoritative, synchronized, uniquely identified by organizational, universal reference situational awareness report or blip on the geo-spatial intelligence screen—the Single Integrated Operational Picture SIOP—from a plurality of existing, in use and described Family of Interoperable Operational Pictures FIOP.

FIG. 11 shows a template system integrated/overlaid with the FCC's Broadband Command and Control Management module FIG. 7 as an example. Describing how a system is made or used is not necessary since the invention is not a single system and since the template system is designed to be used as a procedural template to synchronize and standardized n similar systems is in widespread use. The template's system's usage has been described on television programs such as the Discovery Channel. Existing situational systems, methods, and best practice procedures are to be used to achieve universal standardization in the field of SIOP/FIOP art. The inventor's proposed method of standardization of SIOP/FIOP art has been briefed to NIST, NORAD, NORTHCOM, JFCOM and DHS) FIG. 6 audiences.

The inventor proposes that standardizing situational awareness and understanding, Common Operating picture art/procedures across services, agencies, NGO's (non governmental agencies) be adopted by the National Institute of Science and Technology NIST (sponsor of above cited presentation) and then be presented to the ITU: International Telecommunications Union and ratified by NATO (North Atlantic Treaty Organization), and then by the United Nations.

Unlike Gelvin and Bakke et al cited by the USPTO that focuses on exchanging configuration data between nodes in a master-slave configuration, the Heart Beacon focus is on exchanging temporally synchronized and disciplined and therefore predictable, (FIG. 7 item 1) gathering of state meta data exchanged in a cloud/grid (FIG. 7 center) computing environment focusing on mobility of entire or partial adhoc organizations (FIG. 9 item 14) with the intent to enhance the derivation of a Single authoritative, Integrated Operational Picture SIOP from a Family of Interoperable Pictures FLOP is the intention of the idea.

The patent examiner and supporting USPTO staff is encouraged to seek the assistance of Joint Forces Command JFCOM responsible for cross domain interoperability and DISA Defense Information Systems Agency for standardization for those skilled in the art of Systems Of Systems development as a follow on to the USPTO's referral of this application for military security review in previous application attempts as part of its due diligence. It is not evident that the USPTO has the requisite personnel skilled in the art of this patent application since network centric operations, network enabled operations is at this juncture, still of the military domain. Therefore, the inventor/applicant requests that the USPTO seek assistance to derive requisite skill in the art from the above cited organizations—especially Defense Information Systems Agency (DISA) Network Centric Enterprise Services (NCES) Division who hosted a conference where the inventor presented involving all cited organizations within the past several years.

Heartbeat data messages update net management configuration enables spontaneous integration of adhoc groups synchronizing overlay depictions of actions that enhance situational understanding and enhanced forensic analysis (e.g., the SWIFT protocol) of situational awareness and finance systems as fee for n1-1 Public Services. The Heart Beacon Rainbow Force Tracker: One method fits many; not one size fits all.

The Heart Beacon Rainbow Force Tracker is the reuse of the methods and procedures intrinsic to the most visible of dozens of situational awareness systems Blue Force Tracker—with innovative, paradigm shifting enhancements, improvements addressing key unresolved issues that this application describes. (FIGS. 1a, 1b) General Officers have briefed congress that having anywhere from seven to sixty four situational understanding systems. This system duplication is an issue creating situations where which event or alert blip is the authoritative, actionable one is currently undefined requiring leaders to swivel chair and literally guess as to which screen icon (blip) is the authoritative one. The Heart Beacon Rainbow Force Tracker is not intended to guide one skilled in the arts through a process to develop a working system. That is unnecessary and unwarranted since the system on which the Heart Beacon Rainbow Force Tracker has worked for decades. The Heart Beacon is intended to guide one skilled in the arts to the understanding that a common method/common procedure from an existing, working, fielded to our combat forces a highly visible and advertised system is of benefit to other similar type commercial and private sector systems—especially when user selectable beacon technologies like the FLUX Beacon or Sea Gull Beacon or Boston University's Project Beacon (FIG. 9, item 11) are used as user defined options in a Systems of Systems (SOS) environment that is characteristic of the environment where the Blue Force Tracker was developed. This invention's intent is not to “teach” (explain) how the template Blue Force Tracker system works or how it is used since it has been demonstrated to work and its use described as featured on mainstream television programs and frequent appearances on national news stations. Rather, the purpose of the Rainbow Force Tracker is to take the Blue Force Tracker as a temple system for its methods/procedures (FIGS. 1, 1a, 1b) then add enhancements and improvements, and beacon options (FIG. 4, item 8) to provide a situational understanding methodology (FIG. 3) adaptable and supportable for the greater good across a plurality of situational understanding and event, alert reporting systems in a cloud/grid computing environment.

The novelty of this invention is that the methodology described by this application is only being used by the DOD and the DHS—not yet by the commercial and private sectors (FIG. 1b)—this is the purpose of the Heart Beacon Rainbow Force Tracker.

The Heart Beacon Rainbow Force Tracker is a method of enhancing by innovative modifications to bell weather data exchange/situational awareness systems in use by the Department of Homeland Security since 2004 and by the Department of Defense over the past several decades to synchronize, integrate, standardize and improve interoperability between data exchange/situational understanding systems potentially of all types and all domains. The template system used to support and enable enhancements/innovations is the United States Army's Communications Electronics' Command's USCECOM as sponsored by the Defense Advance Project Administration's (DARPA—who invented the interne initially), Blue Force Tracker. However, other situational understanding systems such as Grenadier BRAT or Canada's Black Coral (Microsoft Groove Networks) based system could have just as easily been used. In the case of Canada's Black Coral based command and control system, Groove Network's framework was used as the sample framework (FIG. 2). Blue Force Tracker is more visible and deployed in greater numbers and is the system with the patent applicant is most familiar. Again, the purpose of this application is not to describe a working, in use system, rather, it is intended to describe innovations of a working system intended to enhance current situational understanding type systems and improve temporal synchronicity, common symbology, the notion of emulating the commander's/leader's intent/scheme of operational maneuver (FIG. 9 items 2, 5) over the network that is common practice in the DOD and the DHS (FIG. 1a). Operational maneuvering is not yet common practice in commercial/private sector domains (FIG. 1b).

Sync seeding the cloud in context with regular, predictable, and managed heartbeat sub-protocol data gathering enables enhanced network effects/network forensics via time synchronized (e.g. Oak Ridge National Laboratories time travel messages), distributed through the cloud providing shared, inter cloud/computing grid synchronized state meta data as public/private fee for services. (FIG. 9) The TCP/IP sub protocol's synchronous data harvesting cycles gathering organizational identification and/or Universal Reference Number URN will in effect ‘sync seed” the cloud computing environment enabling enhanced net effects and net forensics’ through the cloud in context with temporally synchronized shared, cross domain, cross cloud services.

It is significant to point out that one of the key innovations of this application is that the public and private telecommunications providers who supply up to 80% of the military's networked infrastructure do not yet apply the ORG ID or URN. (FIG. 1b, item 4) By doing so, the military will gain an 80% more consistent operational environment while mobility in the commercial sector will improve—using a system developed to defend our nation's freedom to protect us from a wide range of hazards ranging from financial to space systems.

Significance to Cloud/Grid Computing: Heart Beat's intrinsic timing function will synchronize and time stamp data prior to “seeding” it to the cloud (e.g., federal and state data fusion centers) the heartbeat protocol is a mini-publish subscribe function). (FIG. 4, item 3) This is needed since once data is seeded to the cloud, fusion centers must work with the data as harvested/seeded—there is one and only opportunity in time to gather data each heartbeat interval. Service Oriented Architecture SOA products in the cloud provide end to end system heartbeat monitoring the health of applications, and cloud service providers. Once the data is ready to be released from the cloud, selected Beacon technologies will provide network effects (FIG. 9 items 13, 14) such as multicast zone increase/decrease based on condition. When cloud nodes, fusion centers, data base clusters disseminates data, this data will have the intrinsic tagging (ORG ID, URN) to affect a variety of net work effects based on changing intensity, duration, and priority of the event applying the principle of synchronicity to achieve commonality and standardization with the cloud/grid computing environment appearing as one virtual system to the user.

This application addresses the congressional directive: “nothing less than network centric Homeland Security akin to Network Centric Warfare” in context with the need to achieve a universal, global standardized best method/practice in the art of (war) situational awareness/understanding in achieving the Single Integrated Common Picture SIOP derived from a Family of Integrated Operational Pictures FIOP. The area this application pertains is standardizing homeland defense and homeland security network centric procedures—specifically: situational awareness, alerting, emergency response telecommunications among a plurality of complex systems and networks in a cloud computing/grid computing (FIG. 9) environment enabling spontaneous (re) integration” or task (re) organization among disparate, military/commercial systems. Intent: standardization by extension of military network centric warfare procedures developed over decades of operational use (e.g., the Balkan Conflict and Gulf Wars I and II) in use by the Department of Homeland Security since 2004 for situational awareness on its Blackberry (FIG. 6, lower right hand corner) and other hand held smart phone Personal Digital Assistant type devices to enhance and standardize by synchronization, and adherence to interoperability methods to provide situational awareness/understanding as fee for services n-1-1 (i.e., synchronized, standardized 311, 411, 511, 711, and e9-1-1 services.)

The Heart Beacon Rainbow Force Tracking is not:
a single system
a device or single devices
a single instance of anything to be made
a single use item or of a singular nature to be used

2. Description of the Related Art

The Heart Beacon is a grouping of best practices; best methods and procedures (FIGS. 1, 1a, 1b) with user selected software components used to replicate military procedures with the intent of establishing a universal standard in situational understanding/situational awareness

A Department of Homeland Security top three long term goal is (enabling) “A national common operating picture for critical infrastructure”. A congressional directive states “nothing less than network centric homeland security akin to network centric”. A Department of Homeland Security document describing state interoperability funding dated May 2006 states on page 32: a goal to “Improve capacity to include Emergency Medical Service responder status management and vehicle location as an extension of the heartbeat computer aided dispatch system”.

The military provides 20% of its network capacity in South West Asia. The remaining 80% is leased commercial (portfolio) assets. Applying network centric procedures to 100% of the portfolio is Clinger-Cohen Act compliant. A unique aspect of this application is describing a common, consistent, standard method of applying the heartbeat protocol and heartbeat messages/message schemas that are Common Alert Protocol compliant child schemas and/or data islands embedded in the parent and or child schemas depending on the situation/scenario (business logic/mission threads) involved as implemented across x complex systems, y federal, state and local contracts, and z product and system types in a universal, non-proprietary military unique method.

In the spring of 2009 the Joint Forces Command's Interoperability directorate conducted an exercise to affect the procedures/methods/techniques of the Blue Force Tracker Joint Version—JBFSA across federal agencies. The inventor cites this—example as predicate of the applications intent to take this initiative one final step by extending these best practices, methods, and procedures to the private sector. Standards will be defined by NIST/ITU.

As an example of the invention's intent partially realized, Northrop Grumman is applying the cellular heartbeat based UMTS Universal Mobility Telecommunications System in New York City and eighty other cities at the time of the inventor's research in 2008.

Citing the Armed Forces Communications Electronics Association AFCEA Signal Magazine reference below, one of the key systems formats is part military unique (Variable Message Format) and part XML schema that can not be directly exchanged (e.g., messaging) with our commercial emergency notification network (e.g., PSAPs). For example, the Armed Forces Communication's Electronics Association' AFCEA's SIGNAL Magazine article “Defense Knowledge Management Hinges on Compatibility” May 2005. “Using Web services technology and a laptop computer, these researchers separated the Force XXI Battle Command Brigade and Below—FBCB2 application from Blue Force Tracking data according to an established schema. An extensible markup language (XML) wrapper exposed the discovery metadata to a portal for updating every thirty seconds”. “We [9/11 Commission] found no evidence that, at this critical time, during the morning of September 11, NORAD's top commanders, in Florida or Cheyenne Mountain, ever coordinated with their counterparts at FAA headquarters to improve situational awareness and organize a common response. Lower-level officials improvised—the FAA's Boston Center bypassing the chain of command to contact NEADS. But the highest level Defense Department officials relied on the NMCC's Air Threat Conference, in which FAA did not meaningfully participate.”

Thirty second web server refresh rates are not fast enough to prosecute/process/adjudicate objects traveling towards targets at speeds approaching or exceeding mach—hence the need for standard, direct data/message (binary) XML schema exchanges. The most pressing case is the need to exchange data between Federal Aviation Administration PSAP supported networks processing NORAD telemetry data directly with military units of action (i.e., military jets)—as the September 11th World Trade Center scenario.

AT&T has developed a movement detection process that it calls the “Heartbeat Solution.” AT&T has designed its Voice over Internet Protocol—VOIP telephone adapters to enable it to detect when an adapter has been disconnected and then reconnected. Once the Heartbeat Solution detects a reconnection, “the AT&T network will temporarily suspend the customer's service and will post a message at the customer's web portal directing the customer to confirm the existing registered location address or register a new location address.”

APCO/NENA regulations stipulate the heartbeat sub protocol and heart beat messages as do financial Society for Worldwide Inter-bank Financial Telecommunications SWIFT protocol systems and military network warfare systems=the same common denominators. Without consistent, common use of these common denominators in use on every networked device on the planet a Single Integrated Operational Picture SIOP a.k.a. the grail as stated by Office Secretary of Defense OSD IT personnel is not achievable any time soon.

The military provides 20% of its own communications and the remainder it leases from Telco and government contracts i.e., NETWORX. The military will realize an 80% greater usage rate of their Network Centric Warfare and First Responders will be able to achieve standard data interoperability, Synchronicity, and the benefits of network centric operations over the full range of their network portfolio in compliance with the Clinger-Cohen Act of 1996. —and more effectively respond to the next 9/11 type scenario currently impossible due to different data transaction formats and dissimilar, non standard data harvesting intervals.

The Emergency Management Network (EMnet) in use in a dozen states “generates Nadat HEARTBEAT messages to maintain lost connection. EMnet/Emergency Action System (EAS) messages will be delivered to broadcasters within seconds using the secure satellite delivery system”.

During the 2006 National Football League Super Bowl, an approach to fuse sensor data was demonstrated by the 51st Michigan National Guard involving the Transducer Data Exchange Protocol (TDXP). TDXP is implemented over IETF 1451 that interact with Management Information Bases (MIBS) that rely on the heartbeat protocol.

Raytheon/XM Satellite Radio's approach is described “NYC Firefighters plan a military approach to command and control”. By viewing information displayed as an electronic map, fire department commanders will move firefighters, equipment and emergency medical teams in much the same way military commanders shift troops and equipment around a battlefield”.

Cisco Systems Communications Interoperability and Safety Systems—IPICS is “based on proven IP standards” ” the Cisco IPICS server is monitored using a “heartbeat”. “IPICS software uses XML messaging schemas to identify types of communications devices managed by the system.”

Command Enterprise Situational Awareness Control CESAC by Juniper Networks manages the security infrastructure. It centrally configures monitors and manages security devices & effects changes to the security posture IAW threat conditions. Both IPICS and CESCAC are examples of commercial system that will emulate network centric management similar to the military's Tactical Internet Management System TIMS.

Eaton Incorporated's “Home Heartbeat” as the “World's First Home Awareness System” as an example of the technology backed by the ZigBee Alliance of 100 companies employing the ZigBee mesh networking protocol that makes use of the underlying heartbeat protocol. In addition to receiving alerts that a situation like washers overflowing or the garage door is left open when the occupants are scheduled away (an open invitation to terrorist activity), the owners and appropriate first responders will be alerted and situational awareness maps updated.

Geospatial/Dispatch systems like Intergraph's Computer-Aided Dispatch System (I/CAD) use Telco location data: Automatic address input via ANI/ALI (automated number/location information) & Automatic location verification. Vehicle positions from an AVL system auto displayed on I/CAD map on a plurality of military installations.

Telco e9-1-1 PSAP's processing NORAD aircraft tracks and DOD SA systems processing aircraft tracks do not directly exchange messages/XML schema's with each other. Given that up to 80% of a unit's communications will be commercially leased, this implies that only 20% of a force's network centric supporting assets (router/switches) are employing network centric practices and that if these military assets were not available, soldiers would not be able to fight as they have trained nor would they be able to discuss an event with First Responder counterparts given different temporal data collection, screen refresh rates, and geospatial symbol sets.

The heartbeat protocol and heartbeat network reconfiguration messages are part of Defense Information System Agencies (DISA) Network Centric Enterprise Services (NCES) Technology Development Strategy Version Two dated 26 May 2004. The heartbeat protocol as part of DISA's Network Centric Enterprise Services Technical Plan, Telco regulations, and bell-weather IT firms public safety strategies, is a simple but effective method to standardize and thus improve interoperability leveraging the power of network centric warfare/network enabled operations.

Northrop Grumman under a DHS grant provides a situational awareness service covering the Florida Key drug, smuggling interdiction based on their battlefield derived Force XXI Battle Command Brigade and Below/Blue Force Tracking—BFT. The Application Program Interface developer for these systems and the spokes person for the DHS ENFORCE system active in the Florida Keys is the same person—Dave Baxter of Northrop Grumman. Northrop has contracts in New York city and 80 other cities supporting first response leveraging the Universal Mobile Telecommunication System UMTS that in turn leverages the heartbeat sub-protocol to “keep track of user's activities on the network”. This is a clear and present opportunity to standardize.

The Volvo corporation's S-80 vehicle has a “heartbeat sensor” that alerts the driver if the vehicle is occupied with an unexpected, unauthorized occupant sent to the owner's key chain via wireless radio. This is a clear and present opportunity to standardize the transportation sector.

The template system Special Operations Forces Network/SOFNET or FBCB2/Blue Force Tracking has been transitioned to a peer to peer XML messaging system—Sun's JXTA (the other cited system is based on Jabber). This is a clear and present standardization approach.

Mr. Cohen, the DHS former Science and Technology Director stated that “light takes many forms” and “light (beacons) is involved in many areas in the Department of Homeland Security”. The Heart Beacon; yields a Return On Investment for all of us closing terrorist/criminal seams through reuse of (tax payer) “venture capital” for the greater good achieved by standardizing DHS best practice venture capital support of the inventor's claim that technology reuse and standardization already achieved by the DHS adopting DARPA/Army best situational awareness best procedural practice will in turn improve situational understanding across the commercial sector depth and breadth of private corporations, non-profits and Non Governmental Organizations NGO.

Adopted as a standard, template system for Humanitarian operations by SHAPE/NATO/JFCOM as evidenced by the HANDS—Humanitarian Assistance Networked Donor System initiative with Germany as the lead country, Efforts to achieve the adaptation are comprehensively described on numerous Internet websites such as those of the United States Joint Forces Command, the Allied Command Transformation and the German Bundeswehr. Core elements of the improvement of capabilities are the concepts of “Network Centric Warfare” in the United States of America, “Network Enabled Capabilities” in Great Britain or “Vernetzte Operationsführung” in Germany. The key determinants of these network-based concepts are information sharing and collaboration: “Information-sharing and collaboration enhance the quality of information and shared situational awareness. Shared situational awareness enables collaboration and self-synchronization, and enhances sustainability and speed of command.” The widespread use of new Information Communication Technology is intended to enable better exploitation and faster dissemination of intelligence in support of military operations so that political and military decision-making is more authoritative and practical outcomes are more effective. The idea began moving forward from the experimental stage into practical application with “Operation Iraqi Freedom” 2003.

In a February, 2008 article titled “Army to Create ‘Hybrid’ Network of Incompatible Blue-Force Trackers” by NDIA Magazine, “The Joint Battle Command Platform—JBCP will come in several variants. The full-up system will resemble today's FBCB2 (FIG. 1) but soldiers will be able to remove the display unit from the vehicle for dismounted operations. Another variant will be a fully portable device. The third variant functions “MORE AS A BEACON” so that the location of all vehicles and soldiers can be transmitted to the JBCP networks. Our objective is to tie some of these disparate systems together and break down the stovepipes,” said Lieutenant Colonel Grauel. The project office is seeking funds in the 2010-2015 budgets in order to begin fielding the new system in 2012.

During the recently completed Interagency Shared Situational Awareness (IA SSA) Limited Objective Experiment (LOE), U.S. Joint Forces Command and its partners addressed standards, policies and procedures involving sharing of information with interagency, multinational and non-government agencies during crisis operations. IA SSA LOE participants included the Joint Staff, National Guard Bureau, U.S. Northern Command, U.S. Southern Command, U.S. Pacific Command, U.S. European Command, U.S. Africa Command, U.S. Special Operations Command, the Department of State, the Virginia Emergency Operations Center and the aircraft carrier USS Harry S. Truman. During the Interagency Shared Situational Awareness (IA SSA) Limited Objective Experiment (LOE), USJFCOM's Joint Concept Development and Experimentation (JCD&E) Directorate conducted a series of experiments to address standards, policies and procedures involving sharing of information in a distributed environment.

July 29, Law Enforcement Examiner: Homeland Security, Defense Departments plan domestic operations Aug. 2, 11:04 AM 2009. The Pentagon and the Department of Homeland Security recently notified law enforcement agencies, National Association of Chiefs of Police, about the Obama Administration's interest in using the military during “emergencies.” Government officials reported that the Department of Homeland Security's Federal Emergency Management Agency Administrator W. Craig Fugate met with the Commander of the US Northern Command, General Gene Renuart, to discuss “pre-disaster planning, response and recovery in support of the federal response to the 2009 hurricane season as well as wild fires, floods and other potential disasters.” The meeting reinforced the important relationship between the two organizations and focused on the operational role of US Northern Command and what resources and skills they bring to any major Federal effort related to all-hazards preparedness, response, recovery and mitigation, collaboration and cooperation.” This is a clear and present opportunity to standardize situational awareness/understanding best practices, methods, components, into a cohesive, integral whole.

National Transportation Communications for ITS Protocol (NTCIP): The NTCIP stack extends beyond the communications stack to include informational data and interfaces to the physical communications infrastructure. The levels and terminology used in NTCIP were chosen for simplicity and ease of understanding by lay readers, and relevance to typical applications in the transportation industry. This is a joint effort of American Association of State Highway and Transportation Officials (AASHTO), Institute of Transportation Engineers (ITE), and the National Electrical Manufacturers Association (NEMA) sponsored by the US Department of Transportation Research and Innovative Technology Administration. See reference NTCIP 9010: NTCIP Information Report 9010—XML in ITS Center-to-Center Communications periodic update or event-driven), global updates (sync messages). The National Transportations Agency is also the lead on the e9-1-1 Next Generation solution. This example of the art of situational awareness/understanding will be integral in achieving NIST, ITU backed standard methods.

The Healthcare Heart Beacon: Medical triage, alert, evacuation, alternate routing of ambulances will adjust & filter consistently by business logic/mission threads by multicast radius defined zones. Organizations, entities, platforms, vehicle, mobile smart phone type & sensor equipped devices via router/switch network data heartbeat messages updates will spontaneously integrate connecting adhoc medical task forces among disparate entities maneuvering the network to support unified operational, financial, disaster, humanitarian and situation awareness . . . events/alerts/and e9-1-1//n 1-1 Public Services. The National Center for Healthcare Informatics NCHCI provides a national reference and network center located in Montana and is focused on health information technology and health care informatics.

UMTS: Universal Mobile Telecommunications System as used by the NYC public services grid applies the system heartbeat to “track user's activities” enhancing triage and evacuation.

Distributed Instruments states that “TDXP was designed for a Service Oriented Architecture SOA” supporting interoperability between layer one and two (mobile, chaotic environments) with an enterprise level SOA that implements a system wide heartbeat protocol to monitor supported application and system health. The Healthcare Heart Beacon paper linked from inventor's web page is a clear and present opportunity to effect standardized situational awareness procedures and best practices/methods across a Universal Health Care System.

Inspired by a vision of the midnight ride of Paul Revere “one if by land, two if by sea” ride to alert the Colonists to the arrival of the British forces (FIG. 9) Revolutionary War: “If the British march by land or sea from the town to-night, hang a lantern aloft in the belfry arch of the North Church tower as a signal light—one if by land, and two if by sea; and 1 on the opposite shore will be, ready to ride and spread the alarm through every Middlesex village and farm, for the country folk to be up and to arm.” The Heart Beacon Rainbow Force Tracker is an example of the invention's intent to take historical best practice, enhance it and emulate standard procedures in a networked, cloud-grid computing environment.

The Heart Beacon Rainbow Force Tracking as a NIST, ITU ratified procedure will be modified from the United States Communications Electronic Command's “greatest invention” Blue Force Tracking also known as Force XXI Battle Command Brigade and Below—FBCB2. (FIG. 1) Use of a template system (FIGS. 1a, 1b) to derive a unified, universal method/procedure to dynamically reassign tasks (FIG. 9, items 2, 5) orders to organizations that can be further applied across a plurality of networked computer devices supported by a plurality of data exchange systems is the intent of this application. The Department of Defense describes this endeavor—a “Systems of Systems” and/or a “Network of Networks” under the global terms “Network Centric Warfare” and more recently, “Network Enabled Operations”.

The field of the invention involves dynamically reorganizing and reallocating network assets (routers) supporting operational response over TCP/IP networks to disparate domains (FIG. 4, item 7), and communities of interest COT (FIG. 9 item 14).

This invention application is defined by and dependent on the fact that there is no known replacement now or projected for heartbeat/beacon intervals in time/or frames for data collection and transfer of (state meta data) from TCP/IP networked devices (FIG. 9 bottom).

The heartbeat/beacon used interchangeably by industry and in a few instances the terms are combined) is simply an interval in time allocated to gather data from TCP/IP networked devices,

hosts, platforms, smart phones, laptops, handhelds that the Defense Advanced Research Projects Administration DARPA (Vinton Cerf “The Father of the Internet” et al) developed circa forty years ago. The opportunity in time heartbeat data fields will continue to exist into TCP/IP Version 6 and beyond—decades. Vinton Cerf and his team left data fields/time slots open for future applications unknown at that time. Necessity being the mother of invention, his organization DARPA and its subordinate organization US Army Communications Electronics Command USCECOM started to use TCP-IP's unallocated, unused, intervals in time/data fields to gather more data types than before—in particular the Organization ID—ORG ID (FIG. 9 items 14, 16)

Many systems account for single adhoc end user mobility. Few, account for group mobility in context with spontaneous integration with other groups in large organizations e.g., military Divisions, Corps, and more recently, cross agency operational synchronicity. Uniquely tagged state meta data harvested at pre-coordinated, synchronized periods in time yield more versatile network management options for more advanced net forensic functions like adhoc re-organization of disparate units (FIG. 9 items 14, 16). By applying the discipline as to when units may gather data on low bandwidth cellular radio links, saturation and congestion are mitigated—useful in light of the New York City cellular 9/11 scenario.

Expanding on the optional intervals in time left unassigned to gather state meta data from target platforms/devices, involves a discussion of the late 1980's early 1990's Army's Digitization program. Division commanders while undergoing evaluation at the National Training Center in the Mojave Desert would conceive their plans only to have their communications officer or S-6 (system administrator) tell them that their plans were not supportable since the scheme of maneuver involved adjacent units with routers adapted to support tactical radio links that they did not control. The system administrators did not have an ability to easily redefine and change network subnets on the fly using the heartbeat sub-protocol and the heartbeat messages (FIG. 1) developed to propagate router subnet and Domain Name Service changes. The commander's responses were “give us back our pork chops (handsets) then” and our Jon Madden/chalk boards (instead of digital screens). Necessity being the mother of invention, the Communications Electronics Command CECOM's Greatest Invention was realized. CECOM developed the procedures behind Network Centric Warfare typified by Blue Force Tracking. Battle field Digitization begat Network Centric Warfare (FIG. 1). Networks began to be maneuvered to support operational schemes. Units from across the division are mixed and matched based on the situation and spontaneously integrated to fit the mission and commander's intentions.

Health Information Exchange of Montana (HIEM): HIEM will demonstrate best of breed healthcare practice and lead standardization efforts in the area of data aggregation and data distributed by workflow enhancements and disease management functionality by reuse of their pilot targeted at filling present gaps in data, enhancement of clinical communications, alerts (reminders) to adhoc, distributed clinical teams propagating in a standard manner patient data updates. HEIM will lead standardization of workflow (FIG. 2) enhancements to improve clinical workflow (the template system is essentially workflow over multicast) and fill gaps for non-automated participants (secure messaging, forms and notes, alerts and reminders). HIEM will focus on standardizing Community-specific disease management tools for improving the quality of community health care delivery (dashboards and flow sheets) (FIGS. 1a, 1b center) enhanced by using Universal Resource Naming URN and Organizational Identification ID. Data exchange with the State's health exchange, HealthShare Montana will be the standardization hub community for the health care information technology community.

### SUMMARY OF THE INVENTION

Achieve international standard network centric/net-centric procedures and methodologies by reapplying and extending to the commercial, private and non-governmental agencies NIST, ITU ratified methods derived from military's network centric warfare, network enabled operations art. Standardization is the intent, basis of this idea/intellectual property desired by filing this application. The invention advocates universal adoption of military unique techniques of data harvesting/gathering using heretofore unallocated opportunities in time (TCP/IP heartbeat timeslots) for 100% vice 20% of the military's network centric warfare network management portfolio and specifically to extend this procedure/methodology to the commercial private sector for enhanced synchronized public safety as fee for services. A key issue resolved by this invention is that the military's core situational awareness systems and our commercial e9-1-1 emergency and financial (SWIFT) systems rely on heartbeat protocol and heartbeat XML messages—the heartbeat protocol and heartbeat system messages are not used in the same method to achieve the same goals FIG. 9. Specifically the military uses additional and unique military proprietary/XML message hybrid) schema structures e.g., the Joint Variable Message Format (JVMF), United States Message Transfer Format USMTF, Tactical Data Link Messages (TADL) and Situational Awareness Data Link Messages SADLS (FIG. 4 item 9) unknown in (FIG. 4, item 7) commercial and event mainstream federal government organizations.

The Heart Beacon's unique nature involves joint military/commercial initiatives to find a common data message/form/data element format denominator (FIG. 4, item 9) to achieve a synchronized, single authoritative event/alert report or “blip” (FIG. 6) vice multiple e.g., 7 to 64 event/alert unsynchronized and non-authoritative, redundant and therefore confusing, contradictory reports. In common terms, which blip on the screen is live and which is Memorex? The Commander in Chief in the tank beneath the Pentagon must guess between swiveling back and forth between screens as to which system he should rely and make grave decisions.

Differences in community of interest COI, domains, and user groups are addressed by stipulating use of child schemas and or military data elements represented by data islands and/or National Information Exchange Model—NIEM data file payloads embedded in parent Common Alert Protocol—CAP schemas (situation dependent). For example, military Tactical Data Links or TADLS (FIG. 3) used to send telemetry to and from intercept aircraft in a format incompatible with the Federal Aviation Administration's scheme (FIG. 6) that processes North American Radar NORAD tracks through the 6,500+/−Public Safety Answering Points of the e9-1-1 system—a collaborative disconnect in a 9/11 scenario.

A unique, novel aspect of this application is the conversion of Tactical Data Links or TADIL, Variable Message VMF formats three and four digit codes (field unit identifiers/designators or FFIRNS, FFUDNS to equivalent XML tags (FIG. 3) to be reapplied to commercial networks (e.g., E9-1-1 Public Safety Answering Points—PSAPs). Military unique FFIRN (field item reference numbers and FUDNS (field unit number designators that are three and four digit codes) are converted to corresponding DOD Discovery Metadata Standard—DDMS XML tags/commercial equivalent Emergency Data Exchange Language EXDL tags (FIG. 3). These tags as part of XML forms/messages/schemas (only different in name and in structure) will be processed by commercial products intrinsic XML parsing engines or parsers (FIG. 3, FIG. 4). Symbolic or symbol set interoperability and interoperable data exchange between military and commercial counterpart type organizations is the unique value to international event, disaster, alert entities. (FIGS. 3 and 4)

The Heart Beacon describes a method to standardize on a methodology/procedure where router-switch multicast groups for tactical-strategic military systems, first responder and commercial event-alert broadcast services are updated by heartbeat protocol set predefined intervals (e.g., milliseconds, seconds, up to 99 minutes)—FIG. 6. This multicast group data stored in Management Information Bases (MIBS) (FIG. 1, items 6,7) in router/switches is updated by data gathered by the heartbeat protocol as a type of publish subscribe mechanism (FIGS. 1, 8). This network configuration data is then distributed by eXtensible Markup Language—XML heartbeat schemas/messages/forms/reports/documents (only difference in XML is structure) FIG. 2, item 9 that are used to reconfigure unicast-multicast network parameters stored by router—switch management information bases (MIBs). (FIG. 2, item 6).

Disaster/event/alert threshold conditions will be visually increased, decreased on geospatial displays by increasing and decreasing alert/event radius by multicast router hop counts. FIG. 4

Mission graphic overlay with common symbol sets drawing from military, federal, and commercial symbol sets (FIG. 2. GIS server) will standardize and therefore improve operator and group situation awareness by highlighting key spatial information elements of interest directly onto the graphic overlay image (FIG. 2, item 0) such as danger locations, expected locations of aid, landmarks, emergency airfields, etc. Low light, smoke filled scenarios where normal vision is impaired can be improved by use of a handheld or eye mount display in night vision or infrared to maintain an operator's situation awareness during periods of operating in conditions of poor visibility. Accompanying the graphic overlays, synchronization matrixes (word processing tables) may be sent indicating participating organizations on one column and a check or X indicating participation/role. (FIG. 2, forms engine) The operations overlay is a grouping of symbols describing organizational roles vice individual icons. The Sync Matrix or synchronization matrix represents anticipated roles in plans by participating organizations in a event/mission as indicated as checks or X's vice individual symbols and individual roles. Standardization among disparate systems that have the same end goal of providing leaders with a common operational situational awareness picture will be achieved by adherence to military standard iteration of the 9 procedural steps described in FIGS. 1 and 1a converted from a military operational environment (FIG. 1a, Table 2) to a commercial equivalent cloud/grid computing environment (FIG. 1b, and Table 2) Use router/switch network management (re) configuration heartbeat XML messages for disparate, disjoint military and commercial networks thus adopting standardized “spontaneous (re) organization of a plurality of event/alert/information/financial transaction (SWIFT) public fee for services.

Through the use of heartbeat/beacon collected state meta data to “maneuver the network” advanced network management functionality of router will be possible. Else: settle for business as usual situational awareness “jitter” among N systems, fusion centers displayed on a plurality of screens requiring swivel chair analysis given inconsistent symbol sets, too slow 30 second web page screen scrapes caused by on intra-system gateways instead of millisecond beacon technology updates (e.g., the Maneuver Control System Blue Live Feed pre-9/11 scenario).

The Heart Beacon will establish synchronous, standardized date time stamps for financial transactions using the heartbeat process and heartbeat messages to the SWIFT Society for Worldwide Inter-bank Financial Telecommunications System. Using the heart/beacon function will enable assigning time slots for transactions fairly among traders. 1 trader=1 heartbeat interval. Using the publishing/broadcasting function of the heart-beacon process, when a trade is made, an update can be sent to over watch organizations and to clients as a fee for service.

INVENTION KEYWORDS: Heartbeat, Beacon, TCP/IP, heartbeat/beacon sub-protocol, Standard, standards, standardization synchronicity, interoperability, Public Safety Answering Points—PSAPS, e9-1-1 next generation, advanced network reconfiguration management, enhanced network forensic analysis, Six Sigma process, procedures, methodology, spontaneous integration, network centric warfare, network centric warfare enabled operations, XML heart beat UTO messages, XML Messaging with child schemas, data islands and/or NIEM payloads, state management, Universal Message Parsing

Invention key concept: timing and synchronization leading to standardization across n complex systems: There are finite opportunities to collect data each TCP/IP heartbeat beacon sub protocol interval. A device from organization A set at the fastest setting in the millisecond range on low bandwidth radio links will preclude a device from organization B, C, D, and E; from gathering state meta data thus defeating collaboration. The Heart Beacon's enhanced network management and (time slot) discipline will lead from Blue to Grey (commercial) to Rainbow (Universal) Force Tracking. A unique addition is broadcasting alerts and events by exceeded user defined thresholds via multicast radius zones emulating increasing/decreasing events such as earthquakes and (nuclear, biological, chemical) explosions. Use of the universal heartbeat is a means to achieve a time sync standard.

The invention's intent is to standardize by repetition and replication of war proven procedures to organize and “maneuver” military (FIG. 9, items 2 and 5) and commercial leased portions that may be up to 80% leased across the entire homeland security and defense, private sector portfolio. Since the major defense contractors are paired with the major Telecommunication giants bidding on the major (telecommunications) contracts e.g., GSA's NETWORX, the business case to leverage what the government employs across our (inter) national portfolio through the system of systems infrastructure is clear. Congressional directives to establish net-centric homeland security akin to net-centric warfare is met—specifically, the Clinger-Cohen portfolio management act of 1996 (FIG. 5).

Not standardizing on the Heart Beacon's procedures as conceptually described for the sake of a common reference environment—three common denominators iteratively woven through four informational technology IT focus areas, (FIGS. 1a, 1b) is intended to achieve the DOD stated goal of achieving the “grail” or Single Integrated Operational Picture/Family of Interoperable Operational Pictures. The Department of Defense goal of SIOP/FIOP will not be achieved in the foreseeable future—unless this invention is accepted as a standard method by the services, agencies, NGO and international stakeholders.

Principle Operation of the Invention: achieving cross system, inter cloud, cross grid standardization, synchronicity, and interoperability. The invention does not remake what has been made. The invention does stipulate that standard processing of data elements derived from structured military messaging converted to commercial counterpart XML type tags (FIG. 4, Item 9) are then processed by commercial forms engines (FIG. 2) (e.g., Microsoft InfoPath, Microsoft's Groove) with intrinsic message XML parsing processes and state management engines. The Heart Beacon will standardize event, alert, n 9-1-1 information, and emergency response type data filtered by domain/Community of Interest (e.g., medical, financial—SWIFT financial protocol uses heartbeat messages, chemical, transportation, military, first responder, aviation, shipping, news, traffic, health . . . ) resolving to the individual platform level computer device display symbol sets vice a geographic area of interest (i.e., polygon, rectangle, circle, plume) as is the current state of the OASIS standard Common Alert Protocol—CAP. (FIG. 4, item 9)

When the DOD and the world's Telecommunication providers agree on standard common network (re) configuration procedures based on common denominators, direct data/message exchanges and collaboration based on common timing of events and common symbols will be achieved—FIG. 9.

The useful, concrete and tangible result of the method/procedure referred to as the Heart Beacon Rainbow Force Tracker is to provide a standard, universally accepted framework of fundamentals and best practices in data dissemination art as an extension and enhancement of patented processes such as Gelvin and Bakke et al cited by the USPTO.

The invention stands on standards implemented across a plurality of federal, state, local, and United Nation contracts—initiatives—programs to encourage consistency among a plurality of complex systems, agencies, services and nations. The Beacon aspect of the paper (user-community of interest COI selectable and defined) functionally standardizes while maintaining flexibility in the distribution of alerts, warnings, and events via multicast zones representing the DHS five color alert scheme displayed on geospatial displays as router hop counts stored in router MIBS/Light weight Directory Access Protocol LDAP data repositories (FIGS. 1, 1a, 1b, 2, 3).

This application intends to achieve standard data exchange by stipulating the OASIS standard Common Alert Protocol to instantiate data exchanges for cross domain military, first responder, commercial stake holder communities of interest, organizations of action by standardizing data exchange formats, symbol sets, event refresh rates enabling direct collaboration through Public Safety Answering Points that process NORAD air tracks within the FAA network with military telemetry systems using everyday, commercial products to instantiate National Command Authority “chop-chain” release (workflows) (FIGS. 1a, 1b center).

Multicast radius will increase/decrease (FIG. 6) based on business logic/military mission thread logic according to standardized threshold rules visually displayed as concentric color band expansion/collapse based on DHS five level color advisory schemes FIG. 6. Alert, evacuation, alternate routing of transportation assets, medical triage will then be adjustable FIG. 6 by changing multicast radius by DHS color advisory scheme FIG. 6. The viability of commercializing then reapplying the most successful (FIG. 2, item 3) workflow type software/network system in use today that stimulated the genesis of “Network centric” involves simulating a mission thread (military term)/workflow exchange representing the National Command Authority “chop chain” (FIG. 6) using everyday workflow/meta data management tools (FIG. 2) between a representative sample of military and First Responder systems (FIG. 4 and FIG. 6) demonstrating that military network centric procedures can be applied commercially demonstratively improving event mitigation FIG. 9.

Opportunity being addressed (problem being solved): the Heart Beacon for Homeland Security and Defense Interoperability resolves the following types of interoperability/cross domain/Community of Interest COI data exchange standardization issues:

A. Invention Five Key Focus Areas (FIGS. 1a, 1b):

1) Non-interoperability, non standardization of different symbol formats (mil standard vs. .com, gov, .edu., net, .biz). Example: data fusion is impaired by use of non-standard symbolic tagging strategies across XML schema repositories or by mandating the use of a single product i.e., the proprietary Joint Mapping Toolkit JMTK with unique military symbols that civilian, other nations will not rely in favor of their own products and systems. Military uses more detail and resolves to individual vehicle types/platforms/bumper numbers.

2) State meta-data descriptive of network management parameters is more advanced and granular in the military as compared to civilian networks that must co-exist and work collaboratively (non standard TYPES of data harvesting from networked managed devices i.e., military uses the Organizational ID and moves groups of sub-netted IP's in context with commander's intent and scheme of maneuver). Terrorists work on the same civilian networks as do military covert operations units. Therefore, to “maneuver the network” fully, the civilian network must also be maneuvered—in a consistent, predictable, standard method.

3) Non-linkage, non-standard military message threads and commercial counterpart workflows with .gov, .com workflows/business logic i.e., the 9/11 thread between NORAD and the Federal Aviation Administration FAA. NORAD tracks traverse the e9-1-1 Public Safety Answering Point PSAPS yet direct exchange from the PSAPS to military fast movers is not possible given Proprietary, non standard standards i.e., TADL/SADL/OTH-GOLD etc type formats representative of the military—military digital messages formats that use 3 and 4 digit codes vice commercial XML tags converted to binary XML on the fly. Given the need for message gateways; too slow data refresh rates due to web server screen scraping vice direct, millisecond beacon technology exchanges FIG. 2.

4) Achieving standardized data fusion across a plurality of complex systems is not possible any time soon given situational awareness data collection time tagged at different intervals (e.g., millisecond, seconds, 1, 3, 5, 10 minutes—the Fruit Harvest metaphor) FIG. 9. This situation will exist regardless of the sophistication of protocols, products, and systems if this invention's standard method is not adopted and made a standard by NIST, ITU, and OASIS.

5) Non standard alert mechanisms must be addressed through standardization of military mission threads and commercial work flows that are currently not instantiated by a common alert structure or by a single, authoritative organization FIG. 2, item 3 e.g., Common Alert Protocol—CAP) or the Big Red Button metaphor FIG. 9 item 6.

### Example Non Standardization Issue

Scenario: given that there are seven to sixty four Blue Force Tracking Systems in use according to statements made by senior generals to the United States Congress. The situational awareness display observer has the issue of which system provides the ground truth of an event and the intelligence community has the issue of bow to normalize the disparate time stamps of a possible seven different time stamps from the systems representing the same event. Ground truth is currently unclear. A metaphor to describe this issue is harvesting fruit. Fruit must be picked at the optimal time to arrive at the market so that the consumer receives product that is useable and not over ripe or so raw that be undesirable. Fruit, like data needs to be harvested (gathered from networked devices) at scheduled intervals that does not send too much fruit to the markets overwhelming consumer need or too slow, too infrequent to keep up with consumer demand—see FIG. 9 bottom row. If all suppliers gathered data at the millisecond rate, the network (markets) could not support the harvesting rate nor in the case of data, the flood of events be intelligently interpreted by decision makers. Which icon/blip/symbol is the authoritative one is unclear unless a disciplined, prearranged time stamping is agreed upon before the event/alert window (FIG. 6). Decision makers currently must turn from screen to adjacent screen swiveling in their chairs from data/fruit vendor trying to select the optimal event/alert/piece of fruit for consumption. The ideal situation is regulating (FIG. 9) the frequency of data/fruit delivery by customer defined preferences. If every one tries to use the network at the same time, the network saturates. Too slow refresh rates results in stale, useless and undesirable data (fruit).

In the financial domain: investment giants like Berkshire Hathaway's super computers flood (flash trade) massive numbers of transactions into the market telecommunications networks at the start of each trading interval. This gives them an extreme and unfair, non-standardized advantage over the rest of the traders. Using the heart/beacon function will enable assigning time slots/frames/intervals for transactions fairly among traders. 1 trader=1 heartbeat defined interval. Using the publishing/broadcasting function of the heart-beacon process, when a trade is made, notifications/updates are sent to over watch organizations and to interested investors as a standard, fee for service.

The Heart Beacon's seven key standardization initiatives:

1. Establish a common network state data collection time stamp (FIG. 6) via the heartbeat protocol among Situation Awareness (SA) producing systems reducing “swivel chair” analysis by standardizing procedures across high level emergency/military command control centers

2. Improve on faster than 30 second web server/Army Information Server (FIG. 1) derived screen scrape transactions too slow for targeting through use of beacon transponder technology FIG. 1 bottom right. This aspect of the invention's methodology involves flexible selection of beacon protocols FIG. 4 with the proviso that commonly time stamped state meta data is broadcasted over user selected beacon technology.

3. Use of standard (Efficient XML encoded) XML tags vice military unique FFIRNS and FUDNS, DFI—DUIs incompatible with First Responder systems to establish common Symbology FIG. 2. Common symbol displays are achieved by standard data encoding.

4. Resolve the issue of rich encoding (e.g., Microsoft Office Binary Large. Objects—“blobs” on the “upper tactical internet” to users on the “lower tactical internet” (Unix based) that see on the screen unintelligible (mangled) & disjoint synchronization matrixes that are Microsoft Excel spreadsheets on the commercial side of the equation. The NGO/commercial domains do not use sync matrixes. Close the “fidelity gap” Achieving a standard, commonly understood picture requires this.

5. Emulate the DHS Homeland Security Advisory System increasing/decreasing alert radius/event levels via (Sea Gull/Boston U) beacon multicast radius user defined criteria FIGS. 4, 6.

6. Emulate increasing/decreasing alert/event levels by multicast radius translated for blind and deaf (FIGS. 4, 6) and for light degraded situations using of audible step tones like NASA's and National Undersea Research Center NURC's (FIG. 5 center) approach for space/deep sea operations—the higher the tone the greater the interest/risk. NASA/NURC adopted this strategy to conserve power and network resources as well as a means to filter which events/alerts to attend and which to defer or discard.

7. Establish synchronous, standardized date time stamps for financial transactions using the heartbeat process and heartbeat messages to the SWIFT Society for Worldwide Inter-bank Financial Telecommunications System. Using the heart/beacon function will enable assigning time slots for transactions fairly among traders. 1 trader=1 heartbeat interval. Using the publishing/broadcasting function of the heart-beacon process, when a trade is made, an update can be sent to over watch organizations and to interested investors as a fee for service.

### C. Seven Standardization Tasks:

1 Apply as a standard, universal standard TCP/IP heartbeat timed heartbeat messages carrying network heartbeat information formatted in Emergency Data Exchange Language (EXDL) format with DOD Discovery Metadata Specification (DDMS), C2IEDM & JC3IEDM derived XML tags exchanged directly between Network Centric Warfare—NCW systems & sensor net Situational Awareness—SA producers via Telco Public Safety Answering Points (PSAP) for processing and delivery to SA consumers representing high value targets/corporate stakeholders FIG. 2. Use the Common Alert Protocol via domain specific child schemas or by embedding tags in data islands NIEM payloads to cause data cascades/harvesting via military mission threads/business workflow logic—FIG. 2.

2. Collaboratively synchronize both sides of the military/commercial equation allowing disparate military and first responder types to spontaneously (re) organize & standardizing geospatial symbol sets between DOD and First Responder systems permitting apples to apples and oranges to oranges standard collaboration—FIGS. 1a and 1b.

3. Standardize on Common Alert Protocol child schemas/data islands derived from DOD and Federal schema repositories to trigger network data harvesting and dissemination cascades on both sides of the military, federal/private sector equation. Simulate accessing XML schema repositories e.g., DHS/DOJ's National Information Exchange Model (NIEM), Federal XML and the OpenGIS Consortium's OGC XML schema repositories DOD Discovery Metadata Schema—DDMS structured military message set derived XML tags corresponding to legacy Field Unit Designators FFUDS (3 & 4 digit codes)—FIGS. 4 and 6.

4. With the intent of achieving a global NIST/ITU/OASIS standard, commercialize procedures/methodology behind Network Centric Warfare's digital heartbeat & heartbeat derived message sets as published on servers used to reconfigure router/switch multicast IP groups in MIBs supporting “spontaneous (re) integration between military to First Responder groups—FIG. 5.

5 With the intent of achieving a global NIST/ITU/OASIS standard, apply the heartbeat protocol's timing pulse range (millisecond to 99 minutes) for network timing & low level data harvesting mitigating timing jitter in EOC's & Threat Integration Centers. Reapply network centric operations tempo (OPTEMPO) SOPs that set timing parameters for the harvesting & broadcast of data over low to high bandwidth networks mitigating network saturation & too fast/too slow updates—FIG. 4

6. With the intent of achieving a global NIST/ITU/OASIS standard, interleave the Heartbeat International Engineering Consortium (IEC) standard among key services: RFID, PKI, and International ID, and application health status, anti-hacker, SOS & secret service type services supporting systems such as the National Incident Management System (NIMS), the Incident Command System (ICS) as the e9-1-1 Next Generation Solution. FIGS. 4, 6

7. With the intent of achieving a global NIST/ITU/OASIS standard, conduct a simulation/demonstration of a global Net Centric e91-1 Next Generation standard procedure that is product, platform, OS & application neutral. Using facilities like SAIC Corporation's Public Safety Integration Center that displays e9-1-1 Public Safety applications, products, and systems over networks provided by the major telecommunications firms e.g., Verizon, AT&T, SPRINT, and the DHS/DOE NISAC National Infrastructure Simulation and Analysis Center (NISAC) in Albuquerque, N. Mex. NISAC is part of the U.S. Department of Homeland Security's (DHS) Office of Infrastructure Protection and is jointly operated by the Sandia and Los Alamos national laboratories. The center prepares and shares analyses of critical infrastructure and key resources, outlining their interdependencies, vulnerabilities and consequences of disruption. Include The DHS Directorate of Oak Ridge Tenn., and the George Mason University as university technical coordinator working closely with AFCEA International-Armed Forces Communications Electronics Association over the Defense Information Agencies Global Information Grid GIG. Intelligence side of the equation: led by the Technical Working Group TWG and the lead interoperability agency Joint Forces Command JFCOM who in the spring of 2009 demonstrated the template system across federal agencies as a proof of concept/technology show case.

Health Care data Exchange supporting the Health Care Heart Beacon will be lead by Health Information Exchange of Montana (HIEM) who recently demonstrated the dissemination of radiological data through the cloud. FIG. 9

STANDARDIZATION NOTE: While the network timing protocol (NTP) is not a focus of this invention, it is acknowledged as required to provide precision timing to the heartbeat protocol that is currently and will continue to be a multi industry standard among situational awareness (SA) alerting and failover systems until well into the next decade. Point being is that the heartbeat protocol and XML heartbeat message/schemas/forms will be viable for decades. The notion of an opportunity in time to gather data will exist into TCP/IP Version 6 and beyond. The novelty of this invention is that there is no replacement for “intervals in time” as a vehicle to achieve standard temporally synchronized data exchanges.

### BRIEF DESCRIPTION OF THE DRAWINGS

FIG. 1 is a schematic showing the Template method/process/procedure: Network Centric Warfare/Battlefield Digitization

FIG. 1a is a schematic showing the Network Configuration Process Military View

FIG. 1b is a schematic showing the Network Configuration Process Commercial View

FIG. 2 is a schematic showing the Military to commercial conversion view

FIG. 3 is a schematic showing the Universal framework for the Heart Beacon

FIG. 4 is a schematic showing The Heart Beacon Network Radius Beacon Broadcast View

FIG. 5 is a schematic showing The Heart Beacon as Clinger-Cohen Act of 1996 Portfolio Management

FIG. 6 is a schematic showing The Heart Beacon supporting/visually emulating command and control precedence

FIG. 7 is a schematic showing the Quad Chart: 4 IT Management Zones

FIG. 8 is a schematic showing the Three Common Building Blocks iterated through four Information Technology Focus Areas

FIG. 9 is a schematic showing Heart Beacon enhancements to the cloud/grid computing environments

FIG. 10 is a schematic showing the Hear Beacon enhancements as overlayed/integrated with the FCC Broadband Command Control Module

FIG. 11 is a schematic showing and emphasizing the aspect of the Heart Beacon as a procedural enhancement to n complex systems with the FCC Broadband Command and Control Module as one example.

### DETAILED DESCRIPTIONS OF THE DRAWINGS

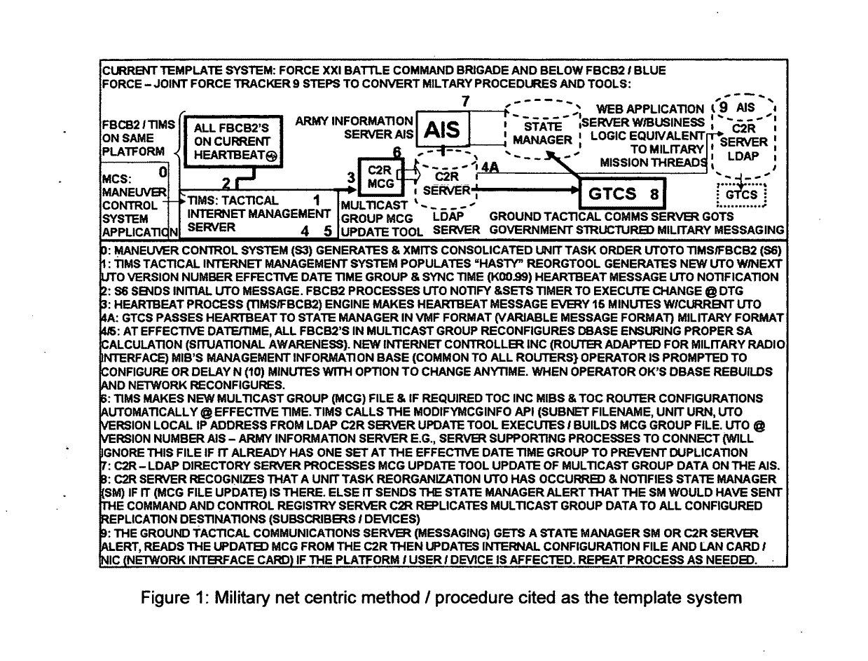

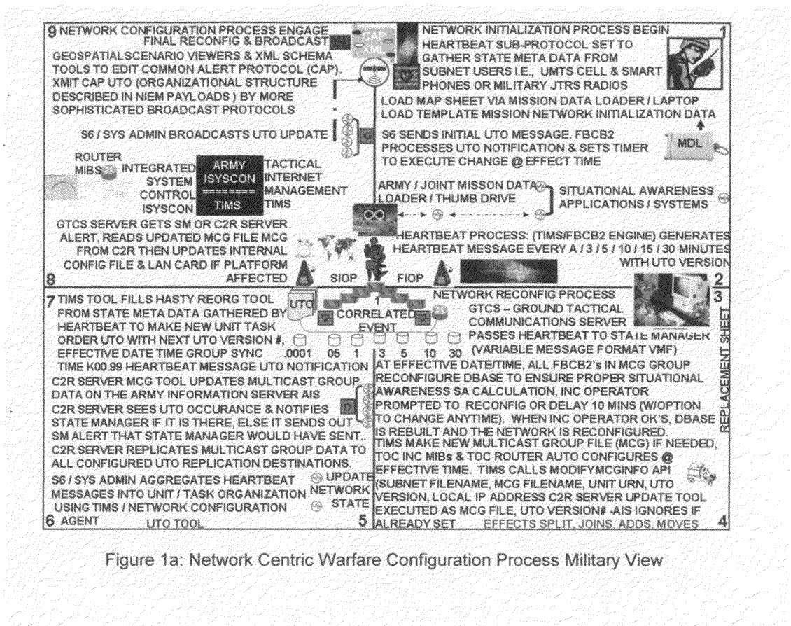

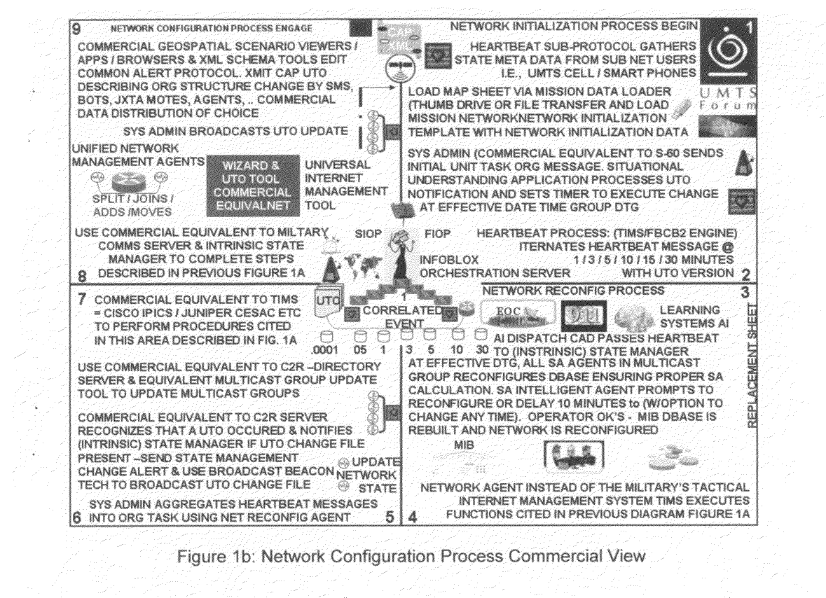

Referring to FIG. 1, current military net centric method/procedure cited as the template system that is to be reused in the commercial sector to achieve intra system synchronicity and enable more advanced network management mobility functions due to gathering additional state meta data every heartbeat data time interval. The additional data types gathered during each heartbeat harvest/get from interval are used by the system administrator—S6 in military terms to re task organize units for action at the network subnet level in router Management Information Bases or MIBs. Table 2 is provided to correlate military unique terms used by this diagram with commercial equivalent terms and indicates the method/procedure flow that is the template flow of this method/procedural application. The numerical steps shown in Table 1, left column are the military's actual steps taken when conducting network centric warfare enabled operations.

FIG. 1a: Military View of the Network Centric Warfare process as the template process for the Heart Beacon. The procedural steps are the same as in FIG. 1 and in the following diagram 1b: commercial view of the Network Centric Warfare Process Situational Awareness process Commercial view.

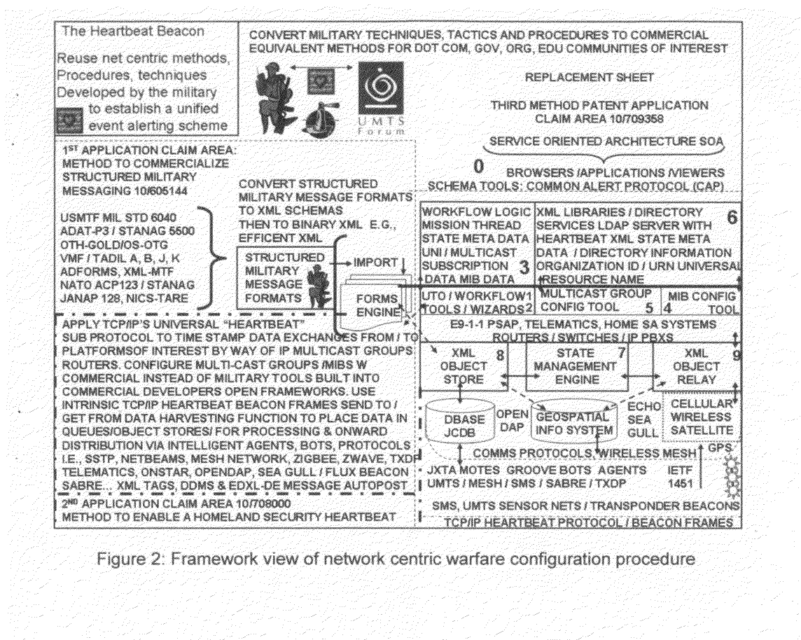

FIG. 1b: View of the Network Centric Warfare process as the template process for the Heart Beacon. The procedural steps are the same as in FIGS. 1, 1a and the following FIG. 2

FIG. 2 Heart Beacon Framework View: Heart Beacon Rainbow Force Tracking universal framework is labeled and divided into three distinct areas. This graphic is derived from the same template applied by the previous applications. The upper left hand corner labeled 1st claim area “method to commercialize structured military messaging” The lower left hand corner is labeled “2nd claim area corresponds The claim area corresponding to this application is the area on the right hand side of the diagram below and above the dashed lines. Describing each claim area in turn:

Claim area one: As structured military proprietary military messages processed by the Ground Tactical Communications Server—GTCS are converted to commercial standard. XML schema's, the underlying government developed message parsers can be replaced by parsers that are intrinsic to commercial products forms engines such as Microsoft's InfoPath. The inventor used Microsoft's Groove Networks Groove's software framework as an example. As the military's FFIRN (federal field reference numbers) and FFUDs (field unit designators) that are three and four digit codes are converted to corresponding XML tags, those tags as part of XML form/messages will be processed by products like Microsoft's Groove or Microsoft's Biztalk, or FusionX, or any other product with an intrinsic forms engine/XML parser enabling symbolic and data element exchange 2nd claim area: The gathering of data/intelligence/network configuration data by the heartbeat protocol is timed consistently by the heartbeat protocol publish/subscribe and data gathering functions on network subnets supporting commercial organizations/military units. As an example, a military medical unit at the scene of a disaster or event would collaborate most efficiently if its counterpart Emergency Medical Service (EMS) team's event refresh rate were consistent to the military's (e.g., every five, fifteen minutes or faster/slower given the scenario/Standard Collaborative Procedure of the unit/organization). Too slow event refresh rates result in data that in the military system used as a template by the inventor (Force XXI Battle Command Brigade and Below—FBCB2) is described as “stale”. Event refresh rates that are too frequent (e.g., milliseconds, 5 seconds . . . ) will saturate low bandwidth links indicative of tactical/chaotic wireless network environments.

Net centric steps of both the military template system and the proposed commercial framework are combined or overlapped in FIG. 2 are numbered 1-9 indicating sequence of method/procedural flow occurring by component or process in the same view to show the intent of this application.

The heartbeat protocol as a low level data harvester gathers network configuration data (e.g., Synchronization Delta Time Block, current UTR (U=Unit, T=Task, R=reorganization) command, Effective Date/Time/Group (DTG) Block, Command relationship (OPCON, attach), Unit of Action, Unit of Employment affiliations, Universal Resource Number URN (unique numeric identification number for each device on network or plurality of networks) current IP lease, multicast group participation, state information such as moment greater than 50 meters, at halt, off line, or straggler, . . . )) that is gathered and forwarded by a plurality of newer, more efficient products, protocols supporting complex systems.

Once multicast subscription group (s) state data is consolidated, data is consolidated by the tactical equivalent of the corporate system administrator or the S-6 in military terms. As described in application Ser. No. 10/708,000, the Tactical. Internet Management System or TIMS is used to configure router management information bases MIBS and associated multicast entries describing the grouping of organizations (units) for missions (Unit Task Order). The S-6/system administrator then broadcasts the updated network configuration data in the form of (K00.99 Variable Message Format) heartbeat messages to higher, lower and adjacent organizations refreshing router/switch unicast/multicast subscriptions. On the military side of this procedural method, situational awareness data subscriptions are updated and units tether and untether to network nodes as they maneuver. A similar process occurs on the commercial side of this methodology as cell phone/smart phone/wireless laptop users tether and untether to cell tower nodes—differently i.e., different heartbeat protocol data collection-distribution rates and different heartbeat XML message schema structures).

### FIG. 2 Continued: Universal Framework

Describing the top most two blocks in the box in the 3rd claim area from left to right: Top most left block labeled Workflow Logic/Unicast-Multicast subscription data: FBCB2/Blue Force Tracking/Land Warrior as the military's main situational awareness propagation systems are workflow logic instantiated by scripts, defined by filters as implemented and broadcast by unicast/multicast IP groups supported by router/switches. Workflow is a commercial mainstay as is subscribing to filtered multicast group content. Since commercially supported first responders and corporate stakeholders networks are also supported by router/switch infrastructure, recognizing this fundamental commonality is one of the basis of claims of Heart Beacon.

Top right block labeled XML repositories, NIEM, JXDM, DDMS, OpenGIS OGC, EDXL-DE formatted sets reference the: National Information Exchange Model—NIEM, Global Justice XML Data Model (Global JXDM), DoD Discovery Metadata Standard (DDMS), Open Geospatial Consortium—OGC. Repositories will provide XML tag repositories for the viewers/applications/browsers to formulate Common Alert Protocol—CAP schemas with Emergency Data Exchange Language Distribution Element (EDXL-DE) formatted messages with child schemas and/or DDMS formatted data islands to bridge emergency response threads between .mil, .gov, .com, .org domains.

The Heartbeat IC00.99 network configuration message initiates a sequence where other data dissemination messages are spawned stimulating operations, intelligence, logistics etc data cascades on the military side of the Heart Beacon equation. A commercial equivalent heartbeat message is needed to instantiate emergency message data cascades on the commercial, organizational side of the equation.

The Common Alert Protocol CAP: “a standard method to collect and relay instantaneously and automatically all types of hazard warnings and reports locally, regionally and nationally for input into a wide variety of dissemination systems” must be designed in a manner that is backwards compatible with current FBCB2/Blue Force Tracking equipped units and forward compatible with Future Combat Systems equipped units that both employ the heartbeat protocol and heartbeat XML network configuration messages for forwards/backwards compatibility.

3rd claim area above the box and below the bracket labeled Service Oriented Architecture—SOA: DISA's Service Oriented Architecture (SOA) product (Amber Point) employs an end to end heartbeat protocol, heartbeat XML message based system health monitor of the Network Centric Enterprise Service—NCES runtime environment that it is offering to all other agencies. Therefore, from foxhole to enterprise, the heartbeat protocol and heartbeat message schema exchange between DOD/military and commercial First Responder domains are key common denominators to increase of the power of network centric by enabling direct military—first responder collaboration mitigating the next (inter) national catastrophic event by improving response times, faster targeting refresh rates, common timing of event sampling and enabling consistent screen refresh rates displaying consistent symbol sets.

Expanding on the application of a Common Alert Protocol designed with child domain schemas/embedded with military DDMS tags, this application is asserting that the military notion of “stragglers” will suit commercial/Homeland Security domains by tracking organizations, units or high profile users. RFID tracked packages that stray from posted itineraries or routines are labeled as “stragglers”. Stragglers on a Blue Force Tracking screen are shown as dimmed or grayed out icons as “stale” since they failed to report within established time limits.

Restructuring the Common Alert Protocol (CAP) by adding nested XML schema elements as data islands or derivative child domain CAP schemas are developed; the intent behind structured military messaging as driven by the TCP/IP heartbeat network reconfiguration process will be combined with a unified CAP structure to achieve a universal military/commercial, JIM (Joint Interagency, Multinational) domain “Heart Beacon” service given North American Aerospace Defense Command—NORAD data is processed by the Public Safety Answering Points but not directly exchanged with the military fast movers (fighters) or air defense units. A recent Signal Magazine article quoted a 30 second web page refresh rate accordingly—too slow for targeting and tracking purposes.

Development of a methodology of nested CAP schema elements and/or derivative child schemas as shown to the right of the 3rd claim area in the included diagram enables the following described functionality:

Radio Frequency Identification RFID where RFID tags if the active type, send data to a network monitoring/relay that sends the date time stamp, service provider or organization data, GPS derived location etc as harvested by the TCP/IP primitive heartbeat mechanisms (2nd claim area) to a threat integration center via router/switches applying the principles behind Blue Force Tracking (BFT) (e.g., filtering applying business rules (mission thread logic in military speak) and FBCB2 as described in this patent and previous patent applications.

If a passive RFID tag, then data and logic to process that data is contained is harvested by application of the TCP/IP send to, get from functions, as timed by the timing function that serves as a trigger to send the harvested data to the monitoring station for onward distribution heeding stored business logic/mission threads filtering methodology.

The application layer logic as carried out by scripts, methods or procedures performs the requisite association of the three and four digit codes that correspond to symbols derived from message data elements that correspond to geospatial symbols applied by geospatial applications such as ESRI's Joint Common Mapping Toolkit—JMTK.

The result of this methodology is that RFID tagged packages, devices or humans wearing RFID tagged bracelets will automatically generate situational awareness data that is granular to ten digit GPS location data and individual platforms and equipment vice general geometric areas of interest and non-GPS derived location data characteristic of the Common Alert Protocol current design.

3rd claim area bottom row description left to right: This area involves Microsoft's Groove software framework as an example of how a product inclusive of a forms engine (e.g., Microsoft InfoPath for Groove and Share Point) will import the converted proprietary military message sets as XML schemas for temporary storage in the XML Object Store until needed as monitored by the intrinsic state management engine prior to onward distribution or relay by the XML Object Relay that is descriptive of the Microsoft Groove product. One of the Department of Homeland Security major projects is based upon Groove Technology and has been deployed to the local/city level thus setting the stage for Heart Beacon. Microsoft Biztalk would be another option.

3rd claim area beneath the framework box description left to right: Database/Joint Common Data Base: database technology for storage and replication/dissemination of XML tagged data timed by the heartbeat protocol.

Geospatial Information Systems (GIS): the prevalent category of enterprise infrastructure that would display/process heartbeat temporally timed event data drawn from common symbol—XML repositories. The GIS interacts with the object stores/object relay as managed by the state management engine of the Heart Beacon solution.

The box labeled cellular, wireless, satellite with the radio Global Positioning System (GPS) label. Military tactical radios i.e., commercial telecommunication cell/smart phones, laptops, handhelds GPS chips for geo location is part of what the heartbeat protocol harvests to determine unit/individual platform status (e.g., straggler, halt, moving, stale, or offline). This state data is harvested by sensor nets—military or commercial (e.g., the indicated Transducer Data Exchange Protocol TXDP & ZigBee 802.15.4 that both ride and make use of the heartbeat protocol).

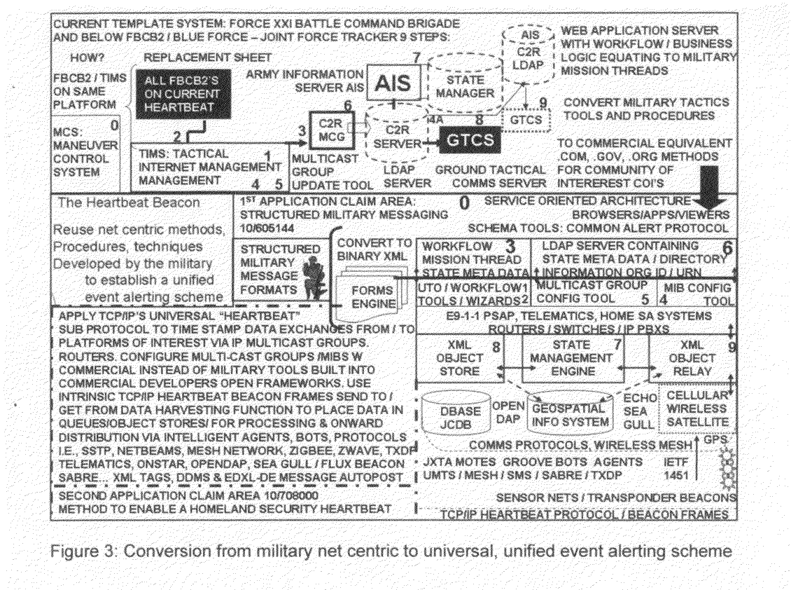

FIG. 3: Conversion from military net centric to universal, unified event alerting scheme. This graphic simply shows the Heart Beacon as a transition from the current military template system to the commercial, universal framework that is platform, operating system, device, system, and application neutral.

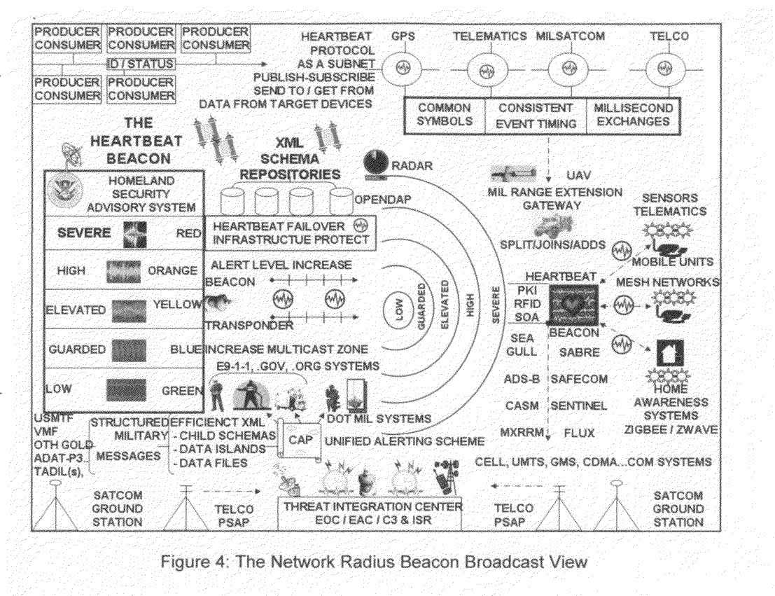

### FIG. 4: The Network Radius Beacon Broadcast View

1. Five level advisory scheme: DHS. DEFCON, COGCON, EMCOM, Military message precedence maintained throughout cloud/grid computing environment and emulated by router/node hop counts corresponding to event intensity, severity, range of impact

2. XML schema repository=storage of CAP, NIEM XML schemas, and artifacts

3. Heartbeat sub-protocol as a mini-publish subscribe mechanism. Cloud/grid computing users may select and use any product or vendor or their choice

4. Common symbols, consistent data harvesting of event data, and millisecond exchanges are three common building blocks required as standards e.g., NIST, ITU

5. Beacon broadcast options selectable by users

6. Event alert intensity, threshold emulation by router/switch/node hop count increase/decrease geo-spatially displayed

7. Sensor technology options use the heartbeat sub-protocol to gather state meta data broadcast, dissemination techniques are options selected by the end user, system

8. Beacon protocol options selectable by user further defines number five

9. Structured military message types converted to open web standards. OASIS

10. Net result of adhering to standards described by numbers 1-9 is that every Threat Integration Center, Tactical Operation Center, e9-1-1 center will display SIOP

### FIG. 4 Continued: The Heart Beacon Rainbow Tracking Beacon Broadcast View

Left middle is the DHS Alert Advisory System. As events occur & reports of events are collected by the heartbeat protocol/Heart Beacon, the alert radius can be increased or decreased according to pre defined ranges by increasing multicast zones via router hop counts. As the event is mitigated, the alert radius is reduced via multicast zone radius. The main alerting mechanism is the presidential ratified OASIS standard Common Alert Protocol or CAP shown here along with the Multilateral Interoperability Programme or MIP as it supports SHAPE: Supreme Headquarters Allied Powers Europe. The MIP program describes structured military messaging and XML message formats.

The heartbeat protocol is part of the TCP/IP stack. Its role in failover sensing for disaster recovery traces back to the TCP/IP's Defense Advance Research Program Administration DARPA origins. The heartbeat protocol/beacon (the term is used interchangeably in throughout the telecommunications industry) can query target devices on subnets for information stored on the device. This information/state meta data such as IP lease, current GPS location & time stamp, current Unit Task Organization UTO and Organizational Identification Number (ORG ID) can be harvested in the millisecond range to up 99 minutes. This data can be placed in local queues, file folders, or data stores for onward distribution by more modern & flexible protocols as an alternative to the military's Ground Tactical Communications Server that processes only military unique formats.

Right middle of diagram: connecting SATCOM and terrestrial networks supporting FBCB2/BFT type split joins corresponding to operational maneuver schemes is Condor's military extension gateway's function. The Heart Beacon's template system is FBCB2/BFT. Transponder beacon technology associated with sensor, mesh, telematic, & home awareness systems can move the data in the same millisecond range that the heartbeat protocol operates. This will enable faster than the current 30 second web page screen scrapes that exists because of data format differences between FAA & .mil systems.

The Heartbeat Protocol icon right center supports a wide range of more sophisticated protocols and technology such as RFID, PKI, Service Oriented Architecture—SOA as well as before mentioned sensor, telematic, mesh, home awareness technology and is mandated by e9-1-1 emergency regulations making it a common denominator promoting interoperability and consistent timing of events.

Left middle is the DHS Alert Advisory System. As events occur & reports of events are collected by the heartbeat protocol/Heart Beacon, the alert radius can be increased according to pre defined ranges by increasing multicast zones via router hop counts. As the event is mitigated, the alert radius is reduced via multicast zone radius. The main alerting mechanism is the presidential ratified OASIS standard Common Alert Protocol or CAP shown here along with the Multilateral Interoperability Programme or MIP as it supports SHAPE: Supreme Headquarters Allied Powers Europe. Medical triage can be affected by the application of filters to alert those needed in an area to converge to a event scene or leave based on more granular military type unique organization ID identifications.

The middle expanding circles of FIG. 4's systems topology view of the Heart Beacon shows Sea Gull beacon's ability to increase/decrease the multicast radius coinciding with the increase or decrease of the DHS Homeland Security Advisory System (e.g., as magnitude of an earthquake increases or as a biological hazard vector spreads or the estimated blast/fall out radius, medicine or food, or product recalls . . . ). The intent here is to preserve machine to machine military INFOCON, DEFCON, ALCON, COGCON levels precedence and to engage organizations of action in a defined area to engage or evacuate based upon unique organizational abilities described by the universal organizational ID code typical of military organizations more so than unstructured comparable civilian structures.

Referencing diagram 3 left hand side of the diagram shows the current Army Battle Command System/FBCB2/Blue Force Tracking procedures in system. On the right hand lower side of diagram 3, a commercialized, product/operating system/application neutral framework supporting the same functions to enable a global Situational Awareness Tone—SA Tone to smart phones & other mobile devices is shown.

The heartbeat protocol as a low level data harvester gathers network configuration data (e.g., current IP lease, multicast group participation, state information such as moment greater than 50 meters, at halt, off line, or straggler . . . ) that is gathered and forwarded by any newer, more efficient products or systems. Once multicast subscription group (s) state data is consolidated, data is consolidated by the tactical equivalent of the corporate system administrator or the S-6 in military parlance. The Tactical Internet Management System or TIMS is used to configure router management information bases (MIBS) and associated multicast entries describing the grouping of organizations (units) for missions (Unit Task Order) and router hop counts of available router/switch devices.

The S-6/tactical system administrator then broadcasts the updated network configuration data in the form of (K00.99 Variable Message Format) heartbeat messages to higher, lower and adjacent organizations refreshing router/switch unicast/multicast subscriptions. On the military side of this procedural method, situational awareness data subscriptions are updated and units tether and untether to network nodes as they maneuver. A similar process occurs on the commercial side of this methodology as cell phone/smart phone/wireless laptop users tether and untether to cell tower nodes—differently i.e., different heartbeat protocol data collection-distribution rates and different heartbeat XML message schema structures). Heartbeat e9-1-1 involves the commercialization of network centric warfare message structures/documents/schemas into Emergency E9-1-1 cell phones and smart phones E9-1-1 Public Safety Answering Points—PSAPs emulation.

This application involves commercialization of military proprietary tools such as the Tactical Internet Management System (TIMS) that produces the UTO—Unit Task Order. The UTO is a message template that military situational awareness applications FBCB2 and Blue Force Tracking) apply. The Unit Task Order is a hierarchical depiction of unit structure showing how units are organized for operations similar to corporate wiring diagrams. UTO distribution is enabled by the use of TCP/IP's heartbeat mechanisms in terms of the heartbeat protocol's send to, get from and timer/data harvest trigger. Ultimately, the big red button requirement is addressed where one authoritative organization triggers event/alert cascades across both military and counterpart federal and civilian organizations and agencies via a single Common Alert Protocol artifact. This function does not yet exist.

Gathering network (re) configuration data used to update tactical/corporate organization/first responder's multicast subscription information based on unit/organizational mission posture change is key Heartbeat e9-1-1 methodology. The commercial equivalent of the military proprietary UTO Tool composes heartbeat protocol gathered network (re) configuration data as a XML EDXL-DE formatted schema with military DDMS data as embedded islands or child schemas. Commercial equivalent UTO tools will exchange these network reconfiguration messages with military counterpart organizations.

Tool functionality includes the feature to update corresponding Multi-Cast Group (MCG) subscription data and Management Information Base (MIB). The UTO is part of the military TIMS (Tactical Internet Management System). The TIMS supports several complex tactical systems (e.g., FBCB2/Blue Force Tracking/Land Warrior). These main situational awareness propagation systems apply workflow logic stored in APIs that are instantiated by scripts, defined by filters as implemented and broadcast by unicast/multicast IP groups supported and enacted by router/switches on the Global Information Grid GIG supporting system of systems and network of networks.

The nearly universal heartbeat protocol as a low level data harvester, publish-subscribe & timing mechanism (2nd Claim Area) harvests & places network configuration data in files, queues, & object stores. Structured military messaging military unique field unit identifiers & field unit reference numbers (e.g., the time honored but now inflexible “FFIRNs and FFUDs” & “DFI, DUI's”) once converted to equivalent XML tags in Common Alert Protocol CAP) child schemas/embedded data islands format will allow nearly any commercial forms engine with an XML parser to parse/process them for delivery by any more advanced sensor/data transport mechanism (e.g., Microsoft's Groove or Biztalk or ZigBee or TXDP . . . etc) providing forward and backwards interoperability & standardization for both the military and commercial systems. Common operational tempo, symbol refresh to Emergency Action Screens will be possible across n complex systems.

The heartbeat protocol and heartbeat XML schemas/messages as designed by the committees and organizations developing homeland defense/homeland security strategies will enable data sharing/workflows between the citizens of our homeland and first responders as consumers of situational awareness information gathered by our military(s)—when they arrive at agreement on the frequency that the heartbeat gathers network configuration data and places that data in queues, files structures, object stores and provided that the heartbeat network configuration XML messages apply common structures and application methodology.

Commercializing the methodology derived from network centric (NCW) where mission threads in military terminology—workflow logic/business rules in commercial terminology initiate message/data exchanges via unicast & multicast IP groups on the battlefield are similarly handled through the world's telecommunications Public Safety Answering Points so that soldiers and first responders will react as they have been trained.

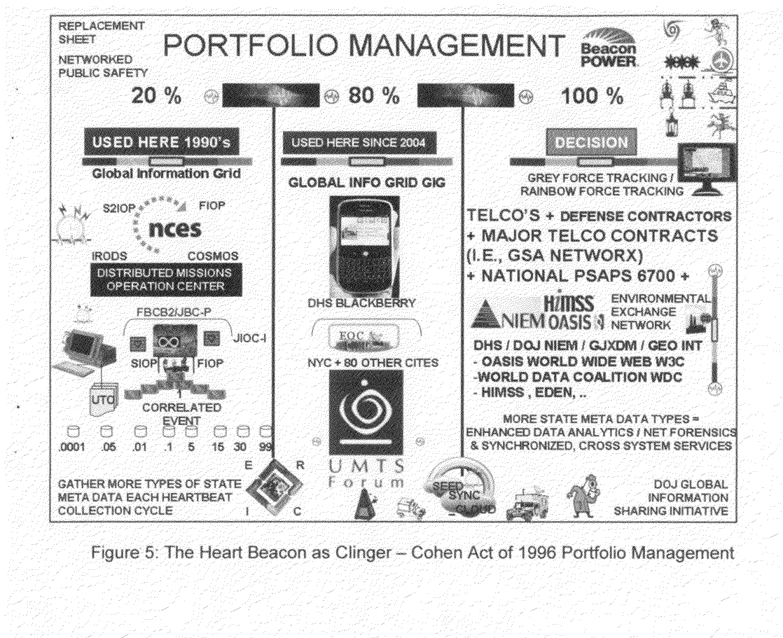

### FIG. 5: Heart Beacon Portfolio Management

The Heart Beacon as Clinger-Cohen Act of 1996 Portfolio Management: The Heart Beacon is based on a program core to the military's situational awareness capabilities that has been in use since before the Balkan Conflict using terrestrial digital radios and after this conflict as satellite broadcast based with Qualcomm's OmniTraks known for tracking trucks and shipping. See above diagram's leftmost “tactical GIG—Global Information Grid section. The middle section suggests that the military apply its network centric warfare procedures to “maneuver the network” and enable “spontaneous” integration to 80% of the network infrastructure that it leases from commercial providers on contracts like GSA's NETWORX offering its procedures to the commercial sector—see right hand panel for an integrated, global, cohesive and temporally SYNCHRONIZED cross system solution. The benefits and “power” of network centric warfare would be increased 80% if not exponentially and to the commercial sector who do not collect the additional state meta data from networked devices that the military does and therefore do not benefit from the enhanced network management and network flexibility options practiced by the military. It makes sound, portfolio management sense to fuse commercial and military best practice to form an interoperable, synchronized, national network through reuse of the Department of Defense's best situational awareness practice derived from the US Army Communication Electronics' Command's Greatest Invention—the template system Blue Force Tracker. Blue Force Tracker, through portfolio reuse becomes the universal Rainbow Force Tracker that meets public safety, financial and information technology open standards.

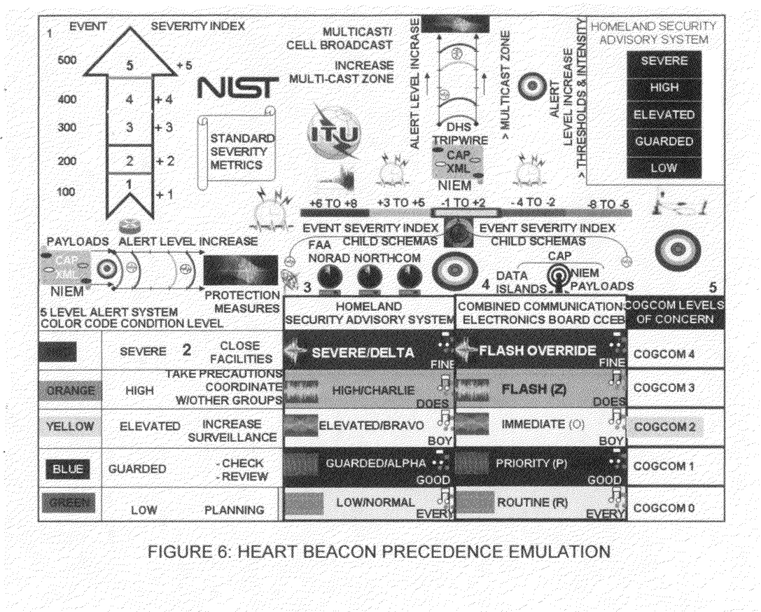

### FIG. 6: Event Severity Index

1. Event severity index—upper left hand corner Center for Disease Control. CDC version

2. Five level national alert system explanation

3. Homeland Security Advisory System

4. Structured Military Messaging (TADILS, SADIL's, USMTF, JVMF, USMTF, OTH-Gold)

5. COGCON Levels: Continuity of Operations General Conditions

FIG. 6 continued: The Heart Beacon as a Single Event/Alert Trigger: The aim of this diagram is the maintaining of machine to machine Precedence, Urgency, INFOCON/DEFCON, COGCOM across N Complex Systems. The Heart Deacon Rainbow Force Tracking's intrinsic date time stamping of transactions serves to maintain machine to machine level processing of precedent levels that are normally on a scale of 1 through 5. The unique nature of this application is to link military alert messaging with its federal and commercial counterparts through a single authoritative XML schema/document based on a single, authoritative situational awareness event/alert across n systems in a system of systems/network of networks. This condition currently does not exist yet is stipulated by Congress is “nothing less than network centric Homeland Security akin to Network Centric Warfare.” Other 5 Key Five Level Systems: NASA & NURC (National Underwater Research Center undersea tone based messaging (for blind handicapped individuals). Precedence is a simple ordering, based on either importance or sequence:
Message precedence of military communications traffic
Order of precedence, the (ceremonial) hierarchy within a nation or state
Order of operations, in mathematics and computer programming
CCEB military precedence: The Combined Communications-Electronics Board (CCEB), a five-nation joint military communications-electronics organization (consisting of Australia, Canada, New Zealand, the United Kingdom, and the United States), uses the following message precedence designators, in descending order of PRECEDENCE: INFOCON levels: NULL/NORMAL/ALPHA (increased), BRAVO (specific risk of attack), CHARLIE (limited attack), and DELTA (general attack).

Not shown: NASA (US Space Agency) and NURC: National Underwater Research Center five level tone based message systems. NASA and NURC systems are superimposed onto items 3 and 4 to show that our (inter) national response strategy should include tones for the blind and vibratory levels for the deaf or for light impaired (dark) situations. Event severity levels will be increased/decreased as event/alert conditions increase or decrease by intensity/threshold levels and emulated geo-spatially as router/switch hop counts—an extension of the Paul Revere “one if by land/two if by sea” paradigm. Paul Revere's paradigm was 3 level i.e., null/0, 1, or 2 lanterns (beacons).

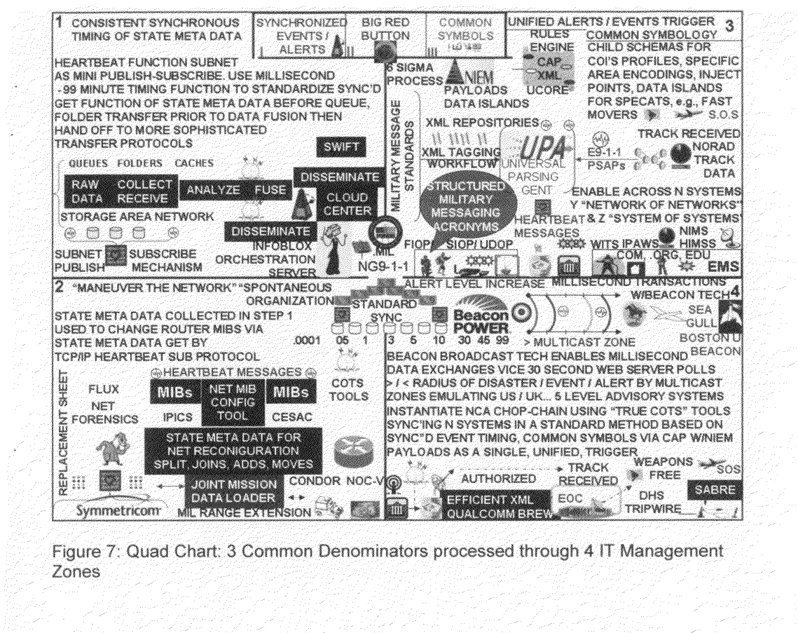

### FIG. 7: Quad Chart: 4 Information Technologies Focus Areas:

1) Establish consistent timing and synchronous state meta-data collection. Use the heartbeat/beacon's (terms used interchangeably) intrinsic millisecond—99 minute timing function to enable consistent, synchronized collection of raw state meta data (geo location, moving, halt, IP address, unit/organization Universal ID) BEFORE transfer to queues, SANS, dbase . . . prior to data fusion activities to improve filtering/data intelligence fusion. Use the heartbeat/beacon function (send to/get from devices, platforms . . . ) as a subnet publish-subscribe e.g., OSD Horizontal Fusion to temporary holding areas awaiting harvesting by more advanced data collection/replication mechanisms that in turn rely on the heartbeat beacon mechanism e.g., OPenDAP, DARPA's Cougaar, UMTS cellular, mesh network ZIGBEE, ZWAVE . . . .

2) “Maneuver the network” Use collected state meta data enabling network management of router Management information Bases MIBs installing network router MIB updates for spontaneous (re) organization split, join, adds via multicast-anycast broadcasts of heartbeat harvested state meta data (geospatial location, status: moving, halt, URN, Org ID, Universal ID)

3) Instantiate National Command Authority NCA chopchain—workflows—business logic over multicast/anycast IP using “true cots” tools in use e.g., Towersoft w/AgileDelta Efficient XML module embedded via the Common Alert Protocol CAP (XML child schemas and or data islands/embedded files) to support the multicast, unicast, or anycast distribution of events, alerts via a unified alert/event trigger mechanism—the OASIS Common Alert Protocol with child schemas and/or data islands conforming to DHS OPEN: Open Platform for Emergency Networks to adjust to Communities of Interest (COI's) needs.

4) User defined beacon technology enabling millisecond data exchanges vice 30 second web server screen scrapes while increasing/decreasing radius of disaster/event/alert radius represented by multicast zones router hop counts corresponding to five level advisory schemes.

THEN: SYNCHRONIZE across N systems, Y networks enabling “the grail” e.g., SIOP/FIOP

ELSE: Situational awareness “jitter” among N complex systems, fusion centers and EOC's. Inconsistent symbol sets, and 30 second web page screen scrapes dependent on intra-system gateways instead of millisecond beacon technology updates (e.g., the Maneuver Control System Blue Live Feed pre-9/11).

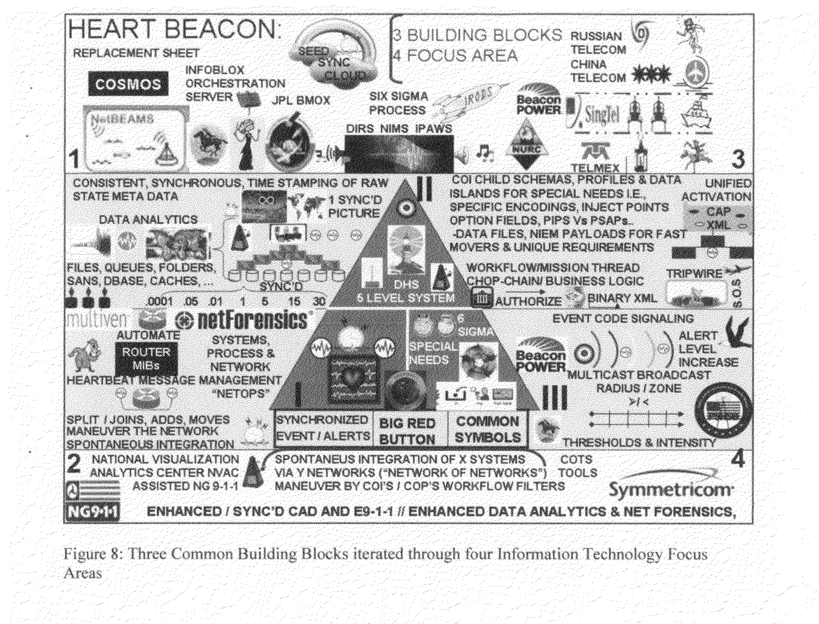

### FIG. 8: Three Common Building Blocks Iterated Through Four IT Focus Areas:

1) TCP/IP heartbeat sub-protocol gathered/harvested state Meta data. Consistent, synchronous timing of platform—device state meta-data collection using the heartbeat/beacon's intrinsic millisecond—99 minute timing function enabling consistent, synchronized collection of raw state meta data (geo location, moving, halt, straggler, duress, IP address, unit/org Universal ID) BEFORE transfer to queues, SANS, dbase . . . prior to distribution/dissemination then data fusion improving filtering/intelligence fusion. Once the time tagged data from multiple, disparate sources, the opportunity to apply network discipline to the gather of this data is gone—the window of opportunity closed. The ability to provide a single, authoritative, data fusion and filtered Single Integrated Synchronous Operational Picture or SISOP cannot be achieved without first applying the simple fundamental discipline at the platform level.

2) Big Red Button as single trigger point, XML schema instantiation point to process Unit Task Order designed to “Maneuver the network”: Collected state meta data enables network management of router Management Information Bases MIBs by installing network router MIB updates for spontaneous (re) organization split, join, adds via multicast-anycast broadcasts of heartbeat harvested state meta data (geospatial location, status: moving, halt, URN, Org ID, Universal ID). The Heart Beacon process will functionally enable re-planning of missions dynamically. It will allow the planning/re-planning processes to be reengineered on the fly to interleave them with cross-domain execution monitoring with automated planning decision aids. Heartbeat network (re) configuration XML schemas/messages

3) Unified, common symbol set used to put everyone on the same visual reference and sheet of music to instantiate the leader/commander's intent through National Command Authority chop-chain—XML workflows—business logic over multicast/anycast IP using “true cots” tools i.e., Towersoft w/AgileDelta Efficient XML module embedded with the Common Alert Protocol CAP (XML child schemas and or data islands/embedded files) broadcasted by multicast of events, alerts via a unified alert/event trigger mechanism. Common Alert Protocol CAP child schemas with embedded data islands/NIEM payloads applied as a single, unified trigger mechanism (e.g., the big red button) for alerts customized for Community of Interests (COI).

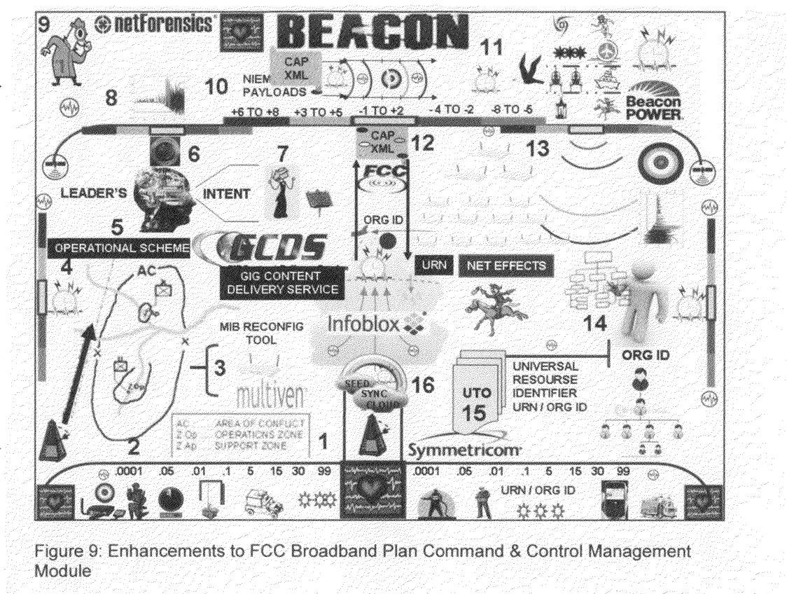

### FIG. 9: Enhancements to FCC Broadband Plan Command & Control Management

Section 16.1 of the Federal Communications Commission's Broadband plan involves enabling a mechanism in place to promote interoperability and operability of the network. The Heart Beacon is adapted from the marquee operational system of the US and NATO armed forces and is a key to affecting operational plans over the network. JFCOM, The Joint Forces Command responsible for interoperability applied the template system across government agencies in the Spring of 2009 as an enabling measure to effect interoperable, operational plans and the commander's intent. The FCC's system (FIG. 9, item 1)—as enhanced by Heart Beacon procedures will effect public safety, financial, and supporting grid/cloud computing infrastructure to realize the benefits of a best of both worlds—fused hybrid commercial, military technological. Given that the military leases the bulk of its network from commercial broadband from Federal Contracts such as NETWORX, it makes sound, portfolio management sense to fuse (FIG. 5) commercial and military best practice to form an interoperable international network that meets public safety, financial, and information technology open standards. The Heart Deacon will help ensure the necessary resiliency, capacity and redundancy, and enhance the public safety community's ability to roam—spontaneously integrating with other adhoc organizations (FIG. 9, items 14, 15) by maneuvering the network (FIG. 9, item 9, 10)—a military developed capability extended and adapted to commercial, rural (FIG. 4, item 7) partners. Commercial operators will be compensated at a reasonable rate on a fee for service basis. Since past efforts to create a public safety narrowband interoperable network have yet to succeed, it is time to effect a tried and battlefield proven approach. The Heart Beacon enhanced public safety broadband network offers a clear and present opportunity to achieve advanced interoperability, net effects, and standard, synchronous operations—now. FIG. 9 continued: FIG. 9 by the number:

1. Heartbeat sub-protocol. interval/opportunity in time to gather data from Internet Protocol IP devices e.g., everything connected to grid/cloud computing Below number 1 is arrayed as pictures representative devices ranging from radios to sensors, to RFID chipped packages.

2. The military and DHS use the heartbeat sub-protocol's RESERVED time slots to gather URN and ORG ID used to “maneuver the network” “spontaneous integration”—commercial/private communities who have yet to adopt this idea/convention.

3. Military maneuver icon: emulate by router/switches subnet organization moves adds, joins

4. Multiven icon: universal router switch management package—user selects product of choice DIIS Alert Advisory System: emulate increasing/decreasing COGCOM, DEFCON, EMCON geo-spatially via router hop counts w/thresholds, intensity levels

5. Commander's/Leader's intentions: emulated by mission threads/business rules, logic enable 1 single event/alert trigger, instantiation point i.e., Big Red Button: through CAP and NIEM payloads and or child schemas and or data islands representing disparate groups and special interest, special needs users (Special Operations Forces, handicapped children)

6. Infoblox's orchestration server icon management server for state meta data

7. Intensity icon—4 DHS Advisory Scheme would increase/decrease by rule

8. Icon and product logo indicates network forensics enhanced by the presence of uniquely Identified organizations (ORG ID), uniquely identified network resources (URN) and predictably time stamped state meta data from target devices.

9. Shows net forensic enhancement aspect enhanced by use of URN, ORG ID, and disciplined e.g., every 5, 10, or 15 minutes and therefore statistically predictable time stamps.

10. Single, cross command, cross agency, international integrated alert/event trigger point

11. Beacon Tech: Sea Gull, Boston U, FLUX Beacon, GM's OnSTAR=Project Beacon 1994

12. CAP Command and Control Module Broadband single event/alert trigger

13. Router switch emulation of five level system by router hop counts cross references to number 4

14. Organizational ID (ORG ID) to enable spontaneous (re) organization of adhoc organizations

15. Unit Task Order UTO XML schema heart beat message sent to update network/cloud

16. Sync Seed Cloud icon: uniquely, systematically time stamp data prior to entry into fusion/cloud computing/grid computing centers. There is one and only one opportunity to do this per heartbeat interval and there is one and only one mechanism (heartbeat sub-protocol) to achieve universal, global, NIST and ITU sanctioned, standardized time stamp protocol.

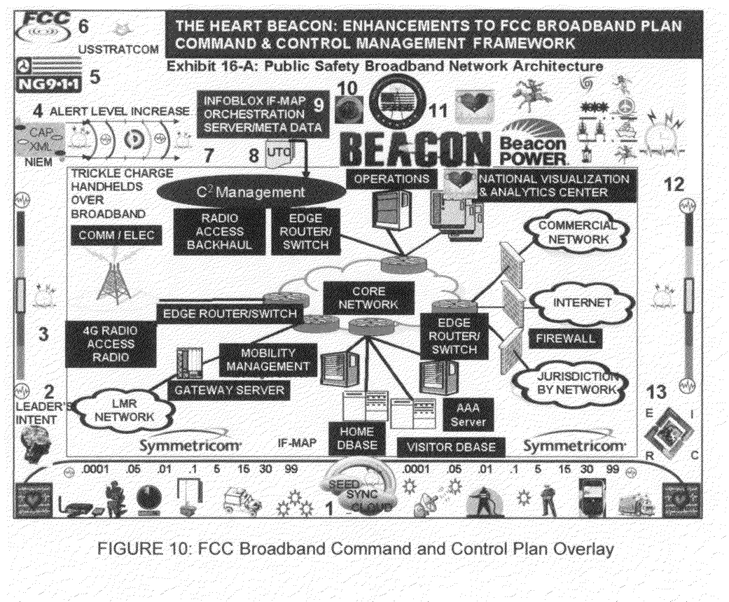

### FIG. 10: Heart Beacon Concepts/FCC Broadband Command and Control Plan Overlay

1. Heartbeat sub-protocol time stamped data: millisecond to 99 minute range

2. Commander's intent emulated over the network e.g., unit split, joins, adds, moves

3 Globally adopted network emulation of synchronous, group mobility oriented advisory strategy via cloud/grid computing environment e.g., International Telecommunications Standard for the World as advanced by the National Institute of Standards and Technology NIST.

4. CAP with National Information Exchange Model NIEM payloads, as a single trigger for events and alerts using child schemas for special interest groups/organizations or data islands.

5. Next Generation E9-1-1 Logo—Department of Commerce funded with the Department of Transportation as lead. The Heart Beacon, years ago, was called Heartbeat e9-1-1

6. Strategic Command STRATCOM as lead of the new Cyber Security Command cooperating with the FCC to implement military network centric procedures/methods/processes

7. DHS Network emulation of Advisory strategy by router, network node hop count

8. Unit Task Order concept from the military/DHS integrated into FCC's strategy—idea sharing

9. Infoblox Orchestration Server: example of heartbeat gathered state meta data support

10. The Heart Beacon serving as a single point of alert/event instantiation—see item 4

11. FCC's division that would logically be in the lead to implement Heart Beacon concepts

12. NVAC: geo-spatial visualization project for geo-spatial display

13. ERIC: infrastructure support program from a sister government agency

Below: Center of Diagram: no numbers or description since this part of diagram is the FCC's diagram. The USPTO is requested to refer to the FCC Broadband Plan's Command and Control initiative for those skilled in the art of information technology planning. ibid with STRATCOM, Department of Transportation, Commerce, Department of Homeland Security (Emergency Response Interoperability Center E.R.I.C).

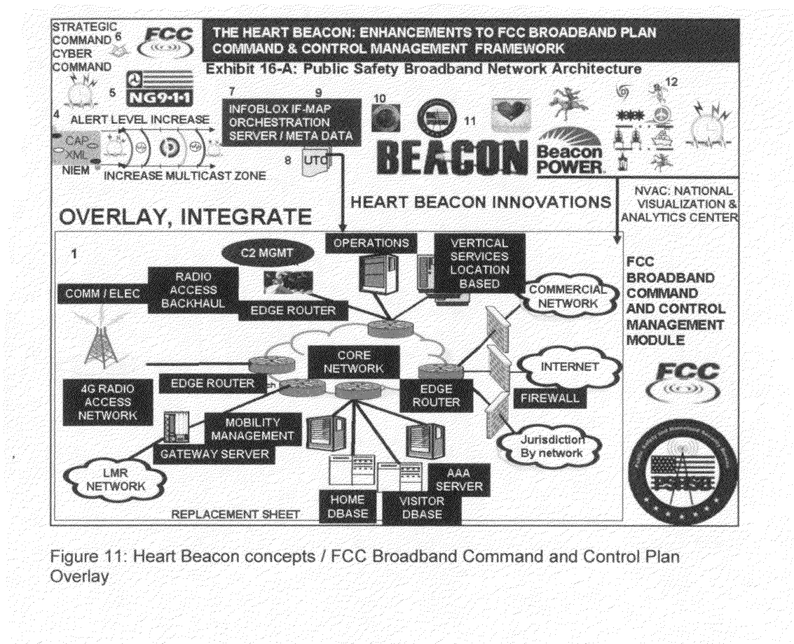

### FIG. 11: Heart_Beacon/FCC Broadband Command and Control Management Overlay

1. FCC Broadband Plan—Command and Control Management

2 Heart Beacon concepts superimposed onto the FCC's graphic. Numbered as in FIG. 7, the intent of FIG. 8 is to show the Heart Beacon as a method of functionally overlapping procedures and best of breed practices over existing systems. FIG. 8 shows as an example, not merging DOD/DHS functionality with the FCC National Broadband strategy means that the DOD and DHS who already make use of the Blue Force Tracker paradigm will never be temporally or operationally synchronized with other services, agencies of the commercial/private sector There will never be the capability to directly interchange data in near real time (useful in interdicting wayward aircraft).

### DETAILED DESCRIPTION OF THE INVENTION

The detailed description will refer to five tables appearing toward the end of this description. The tables are:

Table 1: Template system procedures and components and commercial equivalents

Table 2: Military “operational terms” translated to commercial equivalents. Table 2 is provided to correlate military unique terms used by FIG. 1 with commercial equivalent terms and indicates the method/procedure flow that is the template flow of this method/procedural application.

Table 3: DEPARTMENT OF JUSTICE INITIATIVES//THE HEART BEACON

Table 4: University Technical Lead: George Mason University/The Heart Beacon

Table 5: Health Care Informatics: The Healthcare Heart Beacon

Table 6: Acronyms and Terms

### DETAILED DESCRIPTION OF THE INVENTION

The Heart Beacon is the commercial adaptation of Defense Advance Projects Administration/US Army Communication Electronic's Command USA CECOM's Greatest Invention—the Blue Force Tracker Situational Awareness process for the greater good—specifically, synchronized situational awareness on a fee for service basis.

PURPOSE: Enhance cloud computing, network forensics, data analytics, and address fidelity and fair play among financial transactions e.g., regulate flash trading windows in time/duration while addressing the Department of Defense's grail of a Single Integrated Operational Picture and enabling the network centric warfare rendition of the Commander's Intent/Operations and Fragmentation Orders (i.e., “maneuver the network, spontaneous integration of adhoc units”.

Significance to Cloud/Grid Computing: Heart Beat's intrinsic timing function will synchronize and time stamp data prior to “seeding” it to the cloud (heartbeat protocol is a mini-publish subscribe function). This is needed because once the data is seeded to the cloud, fusion centers must work with the data as harvested/seeded. Service Oriented Architecture SOA products in the cloud provide end to end system heartbeat monitoring the health of applications, and cloud service providers. Once the data is ready to be broadcast/disseminated throughout the cloud, selected Beacon technologies will enable NET EFFECTS such as multicast zone increase/decrease based on defense, event or alert condition. When the cloud rains, it will then rain when after applications, dbases, and communities of action are SYNCHRONIZED together.

Significance of the issue and how it relates to INTERNATIONAL PEACE AND SECURITY:

No national or international entity e.g., United Nations, NATO . . . can achieve a single, unified common operational picture referred to as “The Grail”—this is not a SAW Concepts Term—without the reuse of a procedure developed by the Defense Advanced Projects Administration/United States Army Communications Electronics Command's “Greatest Invention” known as Blue Force Tracking for the greater good. Adding several enhancements to the base procedures will address many issues that contribute to international insecurity such as stock market flash trading, responding to catastrophic destabilizing environmental or war made hazards—by thresholds and intensity levels corresponding to defense conditions, DEFCON, and hazard conditions HAZCON.

How the idea will address the issue: The Wart Beacon addresses the lack of (military research derived) operational discipline in the commercial and corporate sectors and is the logical extension of this discipline into the commercial sector cloud since the military leases up to 80% of its telecommunications infrastructure support. The power of network centric warfare/net enabled operations will be increased at least 80% and by adding a half dozen innovations (i.e., alert by multicast radius by threshold/intensity using intelligent filtering by unique resource number URN and organizational ID ORG ID not currently practiced in the commercial sector) will increase the benefits exponentially while enhancing network forensics and data analytics globally. Since the Heart Beacon is a repeatable process directly adapted from the military's Blue Force Tracking, it is a PROCEDURE and is neutral to all communications technology except the interne itself—i.e., the Vinton Cerf/Defense Advanced Projects Administration DARPA's TCP/IP stack on every networked device on the planet and in space controlled by NASA. The Heartbeat sub-protocol is an opportunity in time to gather state meta data every heartbeat interval. Vinton Cerf and his DARPA team reserved time slots when developing the heartbeat sub-protocol for future use. The US Army in its digitization efforts decided to use the heartbeat sub-protocol as a mini subnet publish-subscribe function to gather data from target devices. Then, they thought of the organization Identification number since the Army usually moves groups/units rather than individual platforms. The Army then devised the Universal Reference Number or URN to uniquely identify units and platforms with the aim to translate unit commander's intent into network mobility equivalents—“maneuver the network”, “spontaneous integration of adhoc units” using military terms. The Heartbeat sub-protocol's intrinsic timing function will allow synchronous time stamping of state meta data including the once optional and military only gathering of a platform's Organizational Identification or ORG ID and/or Universal Resource Number URN. Applying net discipline in data harvesting prior to injection to fusion or cloud computing centers, will enabled enhanced data analytics, network forensics and net effects such as reorganizing adhoc groups on the fly based on leader/commander's intent. Sync Seeding the cloud will enable services that offer synchronized, cross cloud/cross enterprise data services on a fee for service basis.

The military has been using the Heart Beacon's template system derived iterative process for decades. The military applies this procedure to the 20% of its “organic” networks (the equipment it owns and operates itself). The Heart Beacon concept is to extend this process to the 80% of the networks that it leases, then, extend this process to the remaining commercial domains as fee for synchronized, coordinated public services.

Network centric/net-centric procedures and methodologies are applied to the military's organic communications but not the communications assets that the military leases that comprise up to 80% of the total telecommunications portfolio. The idea behind the Heart Beacon is to apply military unique additional data harvesting/gathering using heretofore unallocated opportunities in time (TCP/IP heartbeat timeslots) for 100% of the military's network centric warfare network management portfolio and specifically to extend this procedure/methodology to the commercial private sector for enhanced synchronized public safety services. Although the military's core situational awareness systems and our commercial e9-1-1 emergency systems rely on the heartbeat protocol and heartbeat XML messages—the heartbeat protocol and heartbeat system messages are not used to achieve the same goals.

Specifically the military uses additional and unique military proprietary/XML message hybrid) schema structures e.g., the Joint Variable Message Format (JVMF), United States Message Transfer Format USMTF, Tactical Data Link Messages (TADL) and Situational Awareness Data Link Messages SADLS unknown in commercial and event mainstream federal government organizations. The Heart Beacon's unique nature involves joint military/commercial initiatives to find a common data message/form/data element format denominator to achieve a synchronized, single authoritative event/alert report or “blip” vice multiple e.g., 7 to 64 event/alert unsynchronized and non-authoritative reports. In common terms, which blip on the screen is live and which is Memorex? The Commander in Chief in “The Tank” beneath the Pentagon must guess by swiveling back and forth between screens as to which blip/from 7-64 systems to choose.

Differences in community of interest COI, domains, and user groups are addressed by stipulating the use of child schemas and or military data elements represented by data islands and/or National Information Exchange Model—NIEM data file payloads embedded in parent Common Alert Protocol—CAP schemas (situation dependent). For example, military Tactical Data Links or TADLS used to send telemetry to and from intercept aircraft in a format incompatible with the Federal Aviation Administration's scheme that processes North American Radar NORAD tracks through the 6,500+/− Public Safety Answering Points of the e9-1-1 system—a collaborative disconnect in the 9/11 scenario. A unique, novel aspect of this application is the conversion of Tactical Data Links or TADIL, Variable Message VMF formats three and four digit codes (field unit identifiers/designators or FFIRNS, FFUDNS to equivalent XML tags to be reapplied to commercial networks (e.g., E9-1-1 Public Safety Answering Points—PSAPs). Military unique FFIRN (field item reference numbers and FFUDNS (field unit number designators that are three and four digit codes) are converted to corresponding DOD Discovery Metadata Standard—DDMS XML tags/commercial equivalent Emergency Data Exchange Language EXDL tags. These tags as part of XML forms/messages/schemas (only different in name and in structure) will be processed by commercial products intrinsic XML parsing engines or parsers. Symbolic interoperability and interoperable data exchange between military and commercial counterpart type organizations is the unique value to event, disaster, alerts.

Reuse of a Six Sigma derived method procedure: that is product, system, and application neutral to adapt battlefield proven FBCB2/Blue Force Tracker for First Responder use. The “grail” is to create a single/family integrated operational picture—SIOP/FIOP from cross domain data fusion by Community Of Interest COI's/Public Broadcasting Profile Injection Point PIP profiles. A goal is to provide everyday folks with a UDOP (user defined operational picture) using everyday desktop/personal tools.

The Heart Beacon involves pre and post configuration management of the network and is neutral to systems and middleware. What Vinton Cerf and his team described metaphorically as the heartbeat is actually a interval in time where (state meta) data is gathered and placed into temporary holding areas, queues, file structures for onward delivery by middleware software such as agents, bots, motes, scripts. The heartbeat is an opportunity in time to synchronize data harvesting protecting bandwidth on low capacity networks prior to entry into portals and fusion centers—the point of no return in context with event time stamping. After transition to the middleware or cloud layer, it is too late to try and re-establish timing of event/alert chain of custody. Many systems report the same event at different time intervals. Too fast updates tend to saturate the network. Too slow refresh rates cause the data to be too “stale” for targeting systems. Operational discipline derived from years of military testing and simulation is reused across the entire portfolio of assets. The Deacon process is initiated when agencies act on an event/alert via operational scenario selecting from beacon technologies shaping NET EFFECTS. Multicast broadcasts are shaped and filtered by zones using router hop counts to emulate condition thresholds through visual geospatial views of effect expansion and contractions while filtering desired users and evacuee's in and out of impacted zones enhancing medical triage, and overall intelligent response—the right people in and the evacuees out.

Bio surveillance would improve by improving the consistency of reporting of sensors that may report the same event at different time intervals creating the dilemma of which report from which sensor system is ground truth and which is “memorex”. Depicted alerts by intensity/duration/radius by multicast IP zones according to threshold levels coinciding with the DI-IS color scheme would improve communicating threat level to impacted areas and communities. As events and alerts are filtered by need to know basis on the battlefield, triage instructions and evacuation our of the area of non essential personnel while dispatching appropriate first responders will be improved. Search by unique organizational Identification Name/Universal Resource Number would improve location/filtering of assets as individual assets tend to appear/disappear. Medical surges involve mass casualty alerting and triage techniques and sometimes searching for needles in haystacks. Unique organizational identifiers/universal resource naming would ease this task.

Beacon transponder broadcast protocols such as Sea Gull from U.C. Berkeley University, Boston University's Project Beacon, CodeBlue MoteTrak: Harvard University/Boston Medical CodeBlue system includes MoteTrack, a system for tracking the location of individual patient devices indoors and outdoors, using radio signal information. FLUX: A Forensic Time Machine for Wireless Networks: enables a typical monitoring infrastructure for forensic data collection, storage and analysis support the recording and retrieval of traffic signatures and environmental observations, considered to be a source of network evidence. Medical triage, alert, evacuation, alternate routing of assets will be adjusted by filters using business logic/mission threads to show multicast radius defined zones. Organizations, entities, platforms, mobile smart phone & sensor equipped devices via router/switch network data heartbeat messages updates will spontaneously integrate connecting adhoc medical task forces among disparate entities maneuvering the network supporting unified operational, financial, disaster, humanitarian & situation awareness events/alerts e9-1-1//n 1-1 Public Services

Heart Beacon Rainbow Force Tracking: method enabling Computer Aided Dispatch re-organization. Single, unified Event/Alert trigger. Instantiates synchronous alert/data/event cascades with every day office tools. Common Alert Protocol CAP/NIEM payloads/data islands] as unified trigger across diverse military, first responder, commercial/financial, all hazard domains. Router multicast radius by hop count emulates threshold conditions—increase/decrease with audible tones and vibratory levels for blind/hearing impaired. Threshold conditions display as concentric color band expansion/collapse via router hop counts enhancing medical triage, evacuation, alternate routing of networked entities within geographic zones. Heartbeat data messages update net management configuration enabling spontaneous integration of adhoc task forces. Gathering new data types: Organizational ID and Universal Resource Number URN provides new network forensic analysis and network management techniques. Assigning heartbeat timed transaction windows to financial telecommunications system (i.e., SWIFT) yields transaction time stamping and session duration parity. The Heart Beacon is system, product, device & middleware neutral. “1 Method Fits Many; Not 1 Size Fits All”

TABLE 1
Military “operational terms” translated to commercial equivalents

| Military // Homeland Defense .mil | Homeland Security, .com .org .gov |
|---|---|
| Well-known multicast groups | Subscription service providers for .com, .org, .net etc by |
| | domains maintaining customer/subscriber/employee |
| | multicast groups |
| Doctrinal multicast groups | Multicast groups by domain segment or by formal agreement |
| | (e.g., transportation, security, users by type, service, agency |
| | etc) |
| Moving unit, gaining unit of action, platform | Platform or user/handoff subscriber node e.g., cell tower to |
| tether, un-tether to radio nodes/satellite on the | tower. Satellite radio subscriber. |
| move equipment | |
| Command relationship (OPCON, attach), Unit of | Heartbeat 911 subscriber service, primary provider, affiliate |
| Action, Unit of Employment affiliations | provider, if roaming, affiliating, disaffiliating from cell |
| | towers |
| Effective Date/Time/Group (DTG) Block | Date/Time adjusted for Daylight Savings, world time zones |
| Synchronization Delta Time Block | Time when moving or traveling group executes network |
| | changes that change data distribution routes in supporting |
| | routers |
| UTR (U = Unit, T = Task, R = reorganization) | UTR = Unit Task Reorganization modified = Heartbeat XML |
| command is broadcast to the entire net/subnet | network (re) configuration message sent containing data |
| for execution | changing router Management Information Bases (MIBS) that |
| | change participation in multicast groups subscriptions |
| | reflecting organization structure. Enables military to join first |
| | responder nets and vice verse on an adhoc basis. Accounts |
| | for device mobility. |
| Affected platforms belonging to Moving Unit | Service providers router multi-cast groups change given |
| execute as per the Effective DTG. | organizational changes, user movements, pre-set time |
| | intervals |
| All others not affected execute at | Agreed on time frame e.g., 5 seconds-15-99 minutes for |
| Synchronization Delta Time | heartbeat protocol to harvest then update multicast groups |
| The Heart Beat process incorporates the UTR | “Stragglers” i.e., Radio Frequency Identification Designation |
| command into the periodic Heartbeat message. | RFID tagged package(s), travelers, prisoners . . . not shipped/ |
| This becomes the method by which “stragglers” | departed from a checkpoint or pattern is erratic. Deviation |
| or “stale” platforms re-affiliate/maintain | from schedule exceeding established parameters. Stale - no |
| network configuration synchronization | reports received for set periodic reporting period. |
| Task organization of tactical internet subnets | Changing major internet network configuration subnets based |
| effecting who, when and what to (re) | on major events, or anticipating major movements of |
| organizational/unit affiliations | subscribers (natural, manmade disasters) that change |
| | organizational structure & partnering |

TABLE 2
Military “operational terms” translated to commercial equivalents

| | FIG. 2: Homeland Security, .com .org |
|---|---|
| FIG. 1: Military, Homeland Defense .mil | .gov |
| O: Maneuver Control Systems (S3 | 0: Geospatial, scenario viewers/ |
| Operations Officer) generates & transmits | applications/browsers |
| consolidated Unit Task Order (UTO) to | Schema Tools used to edit Common Alert |
| TIMS/FBCB2 operator (S6) | Protocol (CAP). Transmit CAP Unit Task |
| | Order (organizational structure) user |
| | selected Beacon broadcast protocols, e.g., |
| | via SMS, bots, JXTA motes, agents, email, |
| | Groove Simple Symmetric Transport |
| | Protocol SSTP, any commercial data |
| | distribution, file distribution product |
| | determined by desired effects |
| 1: TIMS—Tactical Internet Management | 1: Wizards & UTO Tool commercial |
| System operator populates Hasty | equivalent e.g., CISCO IPCS, Juniper |
| Reorganization Tool from heartbeat | CESAC used to (re) configure network |
| mechanism state meta data gathered from | management parameters using state meta |
| devices/platforms to generate a new Unit | data harvested by Heart Beacon mechanism |
| Task Order UTO with next UTO version | that is Telco PSAP standard from computer |
| number, effective Date Time Group DTG | devices on TCP/IP networks described by |
| synchronization Time (K00.99 heartbeat | heartbeat message counterpart to K00.99 |
| message option UTO notification) | heartbeat message |
| 2: S6 Sends out initial UTO message. | 2: System administrator/network |
| FBCB2/Blue Force Tracking processes | monitoring software enabled with wizards, |
| UTO notification & sets timer to execute | intelligent software agents sends out unit/ |
| change at effective time | entity/organization task organization |
| | message and sets time for effective time |
| | (when order will be executed) distribution |
| | via workflow tool over Unicast/Multicast |
| | groups by subscription |
| 3: Heartbeat Process: (TIMS/FBCB2 | 3: Wizards & UTO Tool commercial |
| engine) generates “Heartbeat” message | equivalent e.g., CISCO IPCS, Juniper |
| every 15 minutes with UTO version. | CESAC used to (re) configure network |
| | management parameters using state meta |
| | data harvested by Heart Beacon mechanism |
| | from computer devices on TCP/IP networks |
| | described by heartbeat XML message that is |
| | also Telco PSAP and SWIFT |
| | telecommunication standards |
| 4A: GTCS—Ground Tactical | 4a: Beacon Broadcast Tech: SMS, bots, |
| Communications Server passes heartbeat | JXTA motes, agents, email, Groove Simple |
| to state manager (Variable Message | Symmetric Transport Protocol SSTP, any |
| Format VMF) connected to publish/ | data distribution, file distribution product, |
| subscribe agent/subscription manager | system, component used to distribute |
| that sets filter settings capturing user | (binary) XML schema Common Alert |
| defined subscription information | Protocol schema, child schemas, efficient |
| | XML, Binary Runtime Environment BREW |
| | type structures |
| 4/5: At effective date/time, All FBCB2's | 4/5: At pre coordinated data and time, |
| in multicast group reconfigure database to | devices in multicast groups reconfigure |
| ensure proper Situational Awareness SA | router Management Information Base MIB |
| Calculation, new INC (Internet Controller) | Configuration descriptions MIBS (common |
| Operator is prompted to reconfigure or | to all routers - military & commercial) & |
| delay 10 minutes (w/option to change at | distribution lists/subscription lists in |
| anytime). When operator OKs, database is | commercial parlance. (INC: Internet |
| rebuilt & network reconfigures | Controller - a router adapted for combat |
| | radio interface) |
| 6: TIMS generates new Multicast Group | 6: Network Management Application i.e., |
| (MCG) file, and if required, TOC INC | CISCO IPICS/Juniper CESAC makes new |
| MIBs & TOC router configurations | multicast group file used to update router |
| automatically @ Effective time. TIMS | MIBs automatically at agreed on time. |
| calls the ModifyMCGInfo API (Subnet | Unique organization ID is novel aspect. |
| filename, MCG filename, UNIT URN, | Commercial entities usually handle mobility |
| UTO version, Local IP Address LDAP | on a user or case by case basis - not by |
| Command and Control Registry C2R | grouped users represented by (entire) |
| Server update tool executed as multicast | subnets. |
| group file, UTO version number & the | |
| AIS - Army Information Server e.g., | |
| Server running n supporting | |
| processes/apps to connect (will ignore if it | |
| already has one set) | |
| 7. Command and Control Registry C2R - | 7: Command and Control Registry C2R = |
| Lightweight Directory Access Protocol | Lightweight Directory Access Protocol |
| LDAP Server multicast MCG update tool | LDAP Server multicast MCG update tool |
| updates multicast group data on the Army | updates multicast group data on the AIS |
| Information Server | (server) |
| 8. C2R Server recognizes that a UTO has | 8: State Management process on |
| occurred & notifies state manager (SM) if | Information Server/LDAP directory server |
| it is there else it sends out the SM alert | recognizes change has occurred and sends |
| that the State Manager would have sent. | out change alert |
| C2R server replicates multicast group data | |
| to all configured UTO replication | |
| destinations. | |
| 9. Ground Tactical Communications | 9: Beacon tech receives state change via |
| Server GTCS gets SM or C2R server alert, | intrinsic state manager replicating updated |
| reads updated MCG from C2R then | multicast group with routing data from |
| updates internal configuration file & LAN | LDAP server. NIC configured with new IP |
| card if platform affected | lease |

TABLE 3
DEPARTMENT OF JUSTICE INITIATIVES // THE HEART BEACON

| | THE HEART BEACON RAINBOW |
|---|---|
| DEPARTMENT OF JUSTICE | FORCE TRACKING |
| DOJ organizations and units would benefit | TCP/IP's heartbeat as low level publish/ |
| from the ability to synchronize temporally | subscribe & state meta data harvester needs |
| and spontaneously integrate with | commercialization |
| counterpart DHS, DOD, and commercial, | |
| public and private entities by a decade old | |
| procedure in use by DHS with their | |
| Blackberry and other handhelds since | |
| 2004. | |
| Template system adapted to DOJ entities | Template system DARPA/CECOM effort |
| on a case by case basis by Communities of | |
| Interest etc., according to DOJ workflow | |
| logic/business logic/mission threads. | |
| Public Safety Answering Point router/ | Procedures operate within a template |
| switches and computer aided dispatch | integrating C3 & ISR and geographic |
| operations synchronized with DHS Border | systems with commercial sector through |
| Patrol, US Customs, Interpol, NATO, and | world's Public Safety Answering Points as |
| state and local Justice/Law Enforcement | fee for social services. |
| stakeholders. | |
| The Clinger-Cohen Act of 1996 Portfolio | Heart Beacon/Template system is |
| Management supports best performing | essentially workflow over multicast IP |
| programs. The Heart Beacon is derived | designed for low bandwidth IP radio |
| from the US Army Communication | networks. |
| Electronic Command's Greatest Invention. | Heartbeat messages built from state meta |
| The purpose of this grant request is to | data multi/anycasted over the 80% of |
| obtain funds to translate the template | commercially leased networks currently not |
| systems operational and functional | implementing network centric warfare |
| language into Justice and Law | procedures. Application of NCW |
| Enforcement Terms and practices. | procedures across entire portfolio > NCW |
| | benefits. |
| The National Information Exchange Model | Heart Beacon: a universal procedural |
| focuses on the Common Alert Protocol that | template to establish synchronization across |
| currently does not instantiate alerts and | n complex systems, x disparate domains, y |
| events across all stake holders. A | communities of interest, and z First |
| recognized and highly visible expert | Responder types. Without tagging the data |
| agency needs to take the lead in correcting | synchronously and consistently at the point |
| this operational and procedural gap. Since | of harvest, point of entry, no amount of |
| DOJ leads the NIEM, the suggestion is for | data fusion activities by the data fusion |
| the NIEM to lead the rest of the | centers supporting the DOJ/FBI etc will |
| government agencies as is logical for it to | provide a single integrated operational |
| do. | picture SIOP. |
| The DOJ's smart policing initiative would | The Heartbeat/Beacon are terms used |
| not be made smarter if you will by the | interchangeably but in this context are |
| heart beacon per se. It would be made | functionally different in that the heartbeat is |
| more consistent and gain the ability to | intended as the mini data harvester/ |
| determine the authoritative event/alert | publish subscribe where Beacon broadcasts |
| from the many similar yet non- | are intended to fulfill the millisecond range |
| synchronized complex systems feeding | dissemination of sensor systems that rely |
| DOJ/FBI high level operations centers. | on the heartbeat. |
| Smart Policing benefits from military's | Heart Beacon is fundamentally a |
| research into the need to support the adhoc | commercialization and reuses of the |
| (re) organization of units that are | template system that begat Network Centric |
| operationally attached/detached based on | Warfare. Spontaneous integration and |
| mission descriptions. The ability for DOJ | “maneuvering the network” including |
| and military JAG units to spontaneously | commercially based First Responder |
| integrate and exchange data in an apples to | networks is the goal. Computer Aided |
| apples oranges to oranges basis while | Dispatch CAD spontaneous integration of |
| synchronously sharing data and not | disparate groups, teams, and reorganization/ |
| precluding one another from use of the | restructuring based on group rule sets and |
| network by setting their data harvesting | operationally driven reconstitution during |
| rates so fast that no other time slots are | times requiring adhoc grouping to |
| available (saturation/congestion). | accomplish tasks. |
| Smart Policing involves smart organizing | Router - switch multicast radius will be |
| and dispatching organizations and unit and | adjustable - increasing/decreasing with |
| the proper filtering of data as it is | audible tones and vibratory levels based on |
| disseminated by a wide range of | business rules/military mission thread |
| customizable beacon technologies that | logic according to threshold data visually |
| would emulate the pattern of disaster/ | displayed as concentric color band |
| event and conversely the mitigation of this | expansion/collapse based on DHS and |
| event/alert. This would be done by the | other five level color/audible advisory |
| widely available multicast function of | schemes e.g. INFOCON levels. Alert, |
| routers e.g., Verizon VCAST. Qualcomm/ | evacuation, alternate routing of |
| Verizon's announced modulation of the | transportation assets, NBC, medical triage |
| ionosphere for next generation and rural | will then adjust & filter by business logic/ |
| broadband would benefit remotely located | mission threads by zones (e.g., a (blast) |
| DOJ, FBI, Sheriff units - especially in the | wave that travels 30 miles inland with a |
| event of a Coronal Mass Ejection CME. | casualty count >100,000). |
| Harvesting of additional data types enables | Since the procedural template has been use |
| a greater variety of filtering and | in the DOD for a decade and since 2004 for |
| dissemination options - that would | DHS Blackberries, the Heart Beacon is |
| necessarily be triggered by child schemas | essentially education of the commercial |
| and or data islands in the Common Alert | first responder sectors of military more |
| Protocol that currently is not common | advanced network management procedures |
| between military/justice/commercial | |
| entities. | |

TABLE 4
University Technical Lead: George Mason/The Heart Beacon Rainbow Force
Tracking

| George Mason University | Heart Beacon Rainbow Force Tracking |
|---|---|
| DR. J. MARK PULLEN: DARPA lead on TCP/IP | TCP/IP's heartbeat as low level publish/subscribe & |
| commercialization resulting in the Internet | state meta data harvester needs commercialization |
| Dr. Stanley Levine: Former CECOM C2 Directorate | Template system DARPA/CECOM effort |
| Framework Integrating Command & Control Systems, | Procedures operate within a template integrating C3 & |
| Geographic Information Systems and Simulations | ISR and geographic systems with commercial sector |
| | through world's Public Safety Answering Points as fee |
| | for social services. |
| Private Overlay Multicast for the Defense Threat | Heart Beacon/Template system is essentially |
| Reduction Agency Collaboration Center (DCC): The | workflow over multicast IP designed for low |
| message traffic must travel over an arbitrary collection | bandwidth IP radio networks. Heartbeat messages built |
| of Department of Defense (DoD), other Federal and | from state meta data multi/anycasted over the 80% of |
| local governments, and commercial Internet paths | commercially leased networks currently not |
| regardless whether the network operators are willing to | implementing network centric warfare procedures. |
| implement multicasting protocols. | Application of NCW procedures across entire portfolio > |
| | NCW benefits. Router hop counts used to emulate |
| | effect radii. |
| DTRA mission: provide quantitative WMD | Heart Beacon: a universal procedural template to |
| information to operational forces including Department | establish synchronization across n complex systems, x |
| of Defense Forces, other Federal Agencies, State and | disparate domains, y communities of interest, and z |
| local agencies, U.S. coalition partners and first | First Responder types. |
| responders. | |
| Set of tools that enable DTRA to meet mission objects | The Heartbeat/Beacon terms are used interchangeably |
| include the ability to collect real-time sensor data, | but in this context are functionally different in that the |
| analyze the data, and provide real-time information | heartbeat is intended as the mini data harvester/ |
| dissemination to the operational forces in a useable | publish subscribe where Beacon broadcasts are |
| context that supports situational awareness in the | intended to fulfill the millisecond range dissemination |
| operational force C2 systems. | of sensor etc systems |
| The approach to meet the WMD Communities of | Heart Beacon is fundamentally a commercialization |
| Interest (COI) requirement for quantitative information | and reuses of the template system that begat Network |
| is through provision of net-centric technologies, with a | Centric Warfare. Spontaneous integration and |
| scalable topology and process management architecture | “maneuvering the network” including commercially |
| enabling decision support, situational awareness, and a | based First Responder networks is the goal. Computer |
| unique analysis capability. These participants are | Aided Dispatch CAD spontaneous integration of |
| expected to dynamically join and leave the | disparate groups, teams, and reorganization/ |
| communicating groups across the myriad of public and | restructuring based on group rule sets and operationally |
| private networks that make up the DCC user | driven reconstitution during times requiring adhoc |
| community networks. | grouping to accomplish tasks. |
| In the end system or overlay concept, all functionality | IBID. Heart Beacon is fundamentally a network |
| of multicast, including group management and message | management effort involving message replication of |
| Replication, are performed in the end host. provide a | state meta data used to update router subnets adjusting |
| managed multicast service | to operational intent. |
| The simulation tools include realistic physics-based | Router - switch multicast radius will be adjustable - |
| weapons effects and environments. The simulation | increasing/decreasing with audible tones and |
| components provide target management, physics | vibratory levels based on business rules/military |
| calculations and visualization of the results. These | mission thread logic according to threshold data |
| physics models include such items as cratering, | visually displayed as concentric color band expansion/ |
| penetration, external blast, contaminant expulsion and | collapse based on DHS and other five level color/ |
| downwind transport from the target into the | audible advisory schemes e.g. INFOCON levels. Alert, |
| atmosphere. The models use real time data sources | evacuation, alternate routing of transportation assets, |
| such as weather, transportation systems, local | NBC, medical triage will then adjust & filter by |
| population densities, etc. in preparing visualization | business logic/mission threads by zones (e.g., a (blast) |
| results | wave that travels 30 miles inland with a casualty count |
| to the Command and Control | >100,000). |
| DISTANCE EDUCATION | Since the procedural template has been use in the DOD |
| | for a decade and since 2004 for DHS Blackberries, the |
| | Heart Beacon is essentially education of the |
| | commercial first responder sectors of military more |
| | advanced network management procedures |

TABLE 5
University Health Care Informatics/Heart Beacon Rainbow Force Tracking

| Table 5: Health Care Informatics | HEART BEACON RAINBOW FORCE TRACKING |
|---|---|
| Goals: Expand Syndromic Surveillance horizontally | National/Global network forensics enhancements |
| and vertically | horizontally (e.g., DOD's Horizontal Fusion Publish - |
| Bi-directional clinical data sharing | Subscribe based mechanisms across n complex systems |
| Intra-facility data sharing (radiology, laboratory, | achieving synchronicity, interoperability, and common |
| pharmacy, etc.) | symbol sets among disparate user groups. Spontaneous |
| Fully scalable HIE capabilities | integration and maneuvering of the underlying network |
| | supporting adhoc event/alert scenarios. Tap/leverage |
| | every networked device on the planet and in space |
| | (NASA OpenDAP, CLEO, IRIS, tone based |
| | messaging) opportunities in time to harvest state meta |
| | data to achieve more granular network management |
| | independent of product, portals, |
| Data sharing is occurring | Heartbeat TCP/IP sub protocol in use for 4 decades |
| Technology worked “as planned” | Heartbeat sub-protocol = mini publish-subscribe |
| Infinite opportunities to expand and operationalize sic | Template system in use by DHS on Blackberry/Palm |
| technology | devices since 2004. Template system upgraded to |
| | satellite broadcast during Balkan conflict. Template |
| | system developed out of need to convert maneuver |
| | commander's plans into network terms. |
| Agreement between participants (data sources and data | Military mission threads analogous to commercial |
| targets) | workflow. Template system is essentially workflow |
| | logic implemented over low speed radio IP links. |
| | Target platforms are polled by heartbeat every n |
| | milliseconds to 99 minutes. Data transferred to |
| | temporary queues/folders/caches . . . |
| Health Care Informatics | HEART BEACON RAINBOW FORCE TRACKING |
| HP/Palo Alto = The Heart of Silicon Valley | Heart of Silicon Valley House of Representative person |
| House Representative of Palo Alto District is member | is House Medical Technology Caucus member, Vice |
| of Energy and Commerce Committee (the heartbeat is | Chair of the 21st Century Health Care Caucus and |
| the key mechanism for system failover for example the | member of the e9-1-1 Congressional Caucus that is |
| NISAC Infrastructure Test Facility in New Mexico that | important since The Heart Beacon was originally |
| is near the White Sands Missile Range where the | developed as “Heartbeat e9-1-1” and is intended to |
| template system is being tested/enhanced for the | leverage the nation/world's Public Safety Answering |
| military's Network Centric Warfare. | Points PSAPs that also use the heartbeat sub-protocol |
| | and heartbeat state meta data describing messages as |
| | part of Telco regulations |
| Interfaces with Northrop Grumman system | Based on Northrop Grumman system |
| Syndromic Surveillance System shared data elements | Heart Beacon data elements: State Meta Data |
| Information Source ID: code identifies source of data | Universal ID, Organizational ID (OrgID) Event ID |
| Event ID: ID number that represents the patient visit. | Heartbeat time stamp millisecond to 99 minute range |
| Date of the Event: Date of patient visit to Emergency | Geo location (ten digit GPS grid coordinate), Filter |
| Room. | triggers user defined Type of platform/user/ |
| Time, Location, Age, Gender, Weight, Height, and | organization/vehicle bumper # |
| Occupation. | |
| Harmonizing Data Standards | Common Symbol Sets Federal XML state meta data |
| | tags |
| Desirable Characteristics of Software | Defense System Agency Service Oriented Architecture |
| Java/J2EE server platform, Services Oriented | product implements system wide heartbeat. Is Agnostic |
| Architecture | to everything except Internet TCP/IP stack. The |
| Agnostic to: Platform,, Application server, | Heartbeat sub-protocol is intrinsically published - |
| Application database | subscribe mechanism. Advocates unified alert trigger |
| “Publish and Subscribe” model | instantiated from Common Alert Protocol described by |
| Queries: Supports federated (pull), scheduled (push) | data islands and/or child schemas. Notification |
| Plug and play component design | functionalities selected by user desired effects. Beacon |
| Robust, security, auditing and notification | technologies selected by desired effects. Security |
| functionalities | neutral - filtered to protect need to know |
| Detection | Sensor networks and cellular networks employ |
| | heartbeat to “track user activities) i.e . . . , Northrop |
| | Grumman's NYC UMTS |
| Ongoing, systematic sharing, aggregation, analysis, | Focus is on data BEFORE it is deposited in queues, |
| interpretation, and application of near-real time | folders, caches. Common, consistent state meta data |
| indicators that can detect naturally occurring or | time stamping when the data is gathered protects |
| bioterrorist pathogens. | network bandwidth, sets up improved network forensic |
| | analysis (which event is live and which event is |
| | “Memorex” sampled from n complex and similar |
| | systems. |
| Accelerate the broad adoption of EHRs | Standardize data harvesting and dissemination based on |
| Create Interoperable HIE | common, universal building blocks currently used |
| Link disparate, often proprietary, health IT systems | differently is the simplest, most logical path to broad |
| Seek and understand technology opportunities at local | adoption. The military and DHS communities are |
| and regional levels that can build to a national HIE and | mature environments. Designed to link disparate, |
| create data infrastructure | proprietary (military systems use proprietary data |
| | formats = barrier to integration). |
| Overcrowded, understaffed clinical areas with complex | Template system is essentially workflow over multicast |
| workflow patterns, | IP. Is implemented by soldiers in chaotic, sleep |
| | deprived situations |

TABLE 6
ACRONYMS and TERMS

APCO: Association of Public Safety Communications Officials
Beacon Frame: type of management frame, provides the “heartbeat” of a wireless LAN, enabling
stations to establish and maintain communications in an orderly fashion. Consists of: Beacon
interval, Timestamp,
Service Set Identifier (SSID that identifies a specific wireless LAN Source: WiFi Planet
CASM: DHS Communications Assets Survey and Mapping Tool part of SAFECOM Used to
identify communications gaps & close them IAW the SAFECOM Interoperability Continuum
framework
Inventories regional communications equipment assets, while providing a real-time tool to
determine available interoperability links among systems & online equipment inventory
COCO protocol: rides on top of disparate communications systems to give them a common
interface. It establishes a link between systems, negotiating an encoding method and a key
exchange to enable secure communications with quality of service. Commercial equivalent to
military TIMS: Tactical Internet Management Systems
CESAC: Command Enterprise Situational Awareness Control by Juniper Networks is used to
manage security infrastructures. Centrally configures, monitor and manages security devices &
effects changes to the security posture IAW threat conditions.
CISCO Systems IPICS Communications Interoperability and Safety Systems is “based on proven
IP standards” “the Cisco IPICS server is monitored using a “heartbeat”. . . “IPICS software uses
XML messaging schemas to identify types of communications devices managed by the system.”
Commercial equivalent to military TIMS: Tactical Internet Management Systems
Common Operational Picture (COP): A single identical display of relevant information shared by
more than one command. A common operational picture facilitates collaborative planning and
assists all echelons to achieve situational awareness. US Joint Force Common Glossary Free
Dictionary Wikipedia
COGCOM: Combined Communications Electronics Board Levels of Concern: correspond to
DEFCON/EMCOM/ALCOM in context with messaging and data exchange levels of
precedence e.g., flash, priority, routine, immediate, FLASH OVERRIDE.
CONDOR: C2 On-the-Move Network, Digital Over-the-Horizon Relay: maintain reliable
communication across periods of unreliable connectivity through in-network store and forward.
Supports data transfers in which the time-value of the information exceeds the duration of the
network disruption(s)
DEFCON: The Defense Readiness and Force Protection Condition (DEFCON) is a measure of
the activation and readiness level. DEFCON 5 is the usual level of readiness. Standard
peacetime protocol is DEFCON 5, descending in increasingly severe situations. DEFCON 1
represents expectation of actual imminent attack. In a national state of emergency, seven
different alert conditions known as ALCONs can be issued. They consist of five Defense
Conditions and two Emergency Conditions (EMCONs). DEFCON 1 is the point where its time
to dig trenches.
DDMS: DoD Discovery Metadata Specification: common set of descriptive metadata elements
associated with data assets. DDMS defines discovery metadata elements for resources posted to
community and organizational shared spaces. DDMS is a Net-Centric Enterprise Services
(NCES) metadata initiative.
Heartbeat Protocol: A heartbeat is a message sent between machines at a regular interval of the
order of seconds. If a heartbeat isn't received for a time - usually a few heartbeat intervals - the
machine that should have sent the heartbeat is assumed to have failed. A heartbeat protocol is
generally used to negotiate and monitor the availability of a resource, such as a floating IP
address. Typically when a heartbeat starts on a machine it will perform an election process with
other machines on the heartbeat network to determine which, if any machine owns the resource.
Source Vergenet
Efficient XML: binary XML small network footprint alternative to XML schemas that is
especially efficient for transmitting small data files
EXDL-DE: Emergency Data eXchange Language: commercial equivalent to military's DDMS
FFIRN/FFUDs: Field Format Index Reference Number/FUDS: Field Use Identifier
FBCB2: Force XXI Battle Command Brigade & Below/Blue Force Tracking: template system
that is simply stated, a workflow tool executed via router multicast groups adjusted by filtering
logic/algorithms/heuristics embedded in an Application Program Interface API
FLUX: A Forensic Time Machine for Wireless Networks: enables a typical monitoring
infrastructure for forensic data collection, storage and analysis of recording and retrieval of
traffic signatures and environmental observations as a source of network evidence.
INFOCON: INFORMATION OPERATIONS CENTER (INFOCON): Working in concert with
the Force Protection Program, INFOCON recommends actions to heighten or reduce defensive
posture, defend against computer network attacks, and mitigate damage to the DoD and Army
information infrastructure, including computer and telecommunication networks and systems.
Network administrators and Information Assurance Security Officers are primarily responsible
for implementing INFOCON measures.
ITV: Information Transfer Vehicle. From a SAW Concepts LLC standpoint, a commercial
equivalent to the Marine Corps CONDOR vehicle linking disparate networks on the fly
supporting subnet split, moves, adds, joins of disparate organizations. The ITV supports
continuity of operations, emergency response, network restoration, and contingency
management.
MUOS: Mobile User Objective System UMTS: “polls user periodically as a heartbeat
mechanism to track user's activity” “significantly improved and assured communications for U.S.
warfighters”
NACCHO: National Connection for Local Public Health
NENA—National Emergency Numbering Association Technical Support Organization for E9-1-
1 Congressional Caucus
NIEM: National Information Exchange Model: describes XML schemas and structures e.g., data
payloads
OnStar: GM Satellite Division which started as “Project Beacon” in 1994
OPenDAP: Open-source Project for a Network Data Access Protocol is a framework that
simplifies (scientific) data networking. OPeNDAP makes local data accessible to remote
locations regardless of local storage format. It provides tools for transforming existing
applications into OPeNDAP clients (i.e., enabling them to remotely access OPeNDAP served
data).
SABER (Situational Awareness BEacon with Reply) is a battle group situational awareness
system that is capable of determining the location of beacon-equipped tanks, ships, aircraft, and
other military assets worldwide. Using the Global Positioning System (GPS), SABER produces
accurate position and platform identification data and sends that information to tactical users and
global command and control nodes. The SABRE system relays position information via ultra-
high frequency (UHF) line-of-sight and UHF satellite communications (SATCOM) channels.
SEA GULL: Maintains routing and object state using minimal resources e.g. less than 1% of
bandwidth and CPU cycles. Server Heartbeat's “Keep-alive” beacon along each forward link
increasing period (decreasing frequency) with the routing level. It provides data driven server
heartbeat's “keep-alive” multicast to all ancestors with an object pointer that points to root node
and multicasts with increasing/decreasing radius.
Sentinel Beacon: Command Station is a ruggedized PC that receives the data transmitted from
the beacons and processes it to produce location and track information for the incident
commander. The Sentinel Beacon system is designed to work as a mesh network so that a beacon
out of range of the command station can have its data relayed by other beacons.
SAFECOM/Project MESA exists to facilitate dependable, advanced, efficient, effective and
inter-operable equipment, specifications and applications that are involved with public safety-
oriented broadband communication needs.
South West Research Institute Smart Beacons: Worldwide Tracking via Satellite Small,
microprocessor-controlled “smart” beacons allow the location of objects such as aircraft, ships,
and cargo vehicles to be easily monitored
SWIFT: Society for Worldwide Inter-bank Financial Telecommunication System: To identify
Financial Institutions unambiguously, SWIFT developed the Bank Identifier Code (BIC). The
BIC enhances Standard Transaction Protocol in cross-border financial messages. BIC was
adopted by the International Organization for Standardization (ISO). ISO has appointed SWIFT
as the registration authority for the assignment of BICs (ISO 9362) and for the publication of
BICs in the BIC Directory. The SWIFT Telecommunications System uses heartbeat messages.
TRAKPOINT by Mercury Data Systems: GPS-denied position location system Situational
Awareness Suite
Telcordia Domain Announcement Protocol DAP: Beacon Protocol that maintains domains with
network splits and merges. Algorithms dynamically decide domain membership based on node
mobility, roles, etc.
TELEMATICS: integrated use of telecommunications and informatics, sending, receiving and
storing information via telecommunication devices i.e., OnStar by GM
TXDP: Transducer Data Exchange Protocol: used during 2005 Super bowl by Michigan National
Guard
UMTS: Universal Mobile Telecommunication System (wireless broadband) heartbeat to “track
user's activities”
ZIGBEE: Consortium supporting a heartbeat driven mesh network standard
ZWAVE: like ZIGBEE (70+ competing standards)
Note:
Heartbeat, Beacon, Beacon Frames, Heartbeat chunks, beacon heartbeat are interchangeable terms within the telecommunications industry. Usually, the heartbeat function refers to the device keep alive function to determine if the channel/devices are up or down (operational). This invention acknowledges this functionality but does not concern itself with this particular capability; rather, this invention focus is on the opportunity in time that a heartbeat/ beacon and the aforementioned variations as an opportunity to gather state meta data from a plurality of networked devices (e.g. handhelds, laptops, smart phones, sensors, and any TCP/IP supported computer devices).

What is claimed is:

1. A method of claim standardizing procedures/methods/processes, and practices intrinsic to military Network Centric Warfare (NCW) situational awareness systems extending these best methods and practices to the private grid/cloud computing sector re-using NCW templates as functional, operational guides/references enabling enhancing, unified alert, event, All Hazards processes (e.g., Single Integrated Operational Picture SIOP from a Family of Integrated Common Pictures FIOP) by commercial (NIST, ITU, OASIS) adoption of a standardized nine step iterative process/method.
a) Use TCP/IP heartbeat sub-protocol frames/intervals in time to gather/harvest/collect then place state meta data in temporary holding areas i.e., file, queue, folder, cache from a plurality of TCP/IP cloud/grid/networked computing devices, sensors and Radio Frequency Tags RFID;
b) Use TCP/IP heartbeat sub-protocol uses as a timer (i.e., 0001, 001, 05, 01, 1, 5, 10, 15 . . . 99 minute) synchronizing timing/temporal rate of state meta data collection across a plurality of inter networked cloud/grid computing devices;
c) Use TCP/IP's time stamping function (i.e., 10:15 AM) enhancing network forensic analysis by gathering additional state meta data types (ORG ID, URN) using heretofore reserved time slots at disciplined, and therefore statistically predicable intervals (e.g., 5, 10, 15 . . . minutes);
d) Use TCP/IP's multicast/unicast/anycast function of routers emulating geographic area alerts via router hop counts in context with DEFCON, ALCON, COGCON, INFOCON, and (DHS) five color level advisory schemes;
e) Use TCP/IP multicast-unicast process to distribute/broadcast mission thread/business logic contained in workflows as synchronized, filtered subscription services to users supported by a cloud/grid distributed, adhoc, mobile, network sensor computing environment;
f) Use TCP/IP millisecond response range function to improve on the current too slow for fast moving objects 30 second web server screen scrapes of data refresh rates to Command and Control and Emergency Operation Centers/nodes/systems;
g) Use TCP/IP timing function to synchronize/standardize date time stamping by uniquely identifying by creating disciplined, predictable data transaction windows (start, stops, duration) for alerts and events including financial transactions (i.e., SWIFT), enhancing net forensic analysis by providing notifications of events, alerts, and change conditions on a fee for service basis;
h) Standardize heartbeat sub-protocol gathered and synchronized thus standard and predictable state meta-data refresh rates to enhance the consistency of cross system, cross cloud/data grid derived Single Integrated Operational Picture (SIOP).

2. A method of claim where proprietary military network management functionality is replicated to standardize as best practice enhancements/improvements to equivalent commercial network management system imparting to commercial domains the military's superior network mobility practice emulating leader/commander's intent (maneuver the network, spontaneous integration of mobile, adhoc units).
a) Use commercial wizards & UTO Tool commercial equivalent e.g., CISCO IPCS, Juniper CESAC instead of proprietary military tools (i.e., TIMS) reconfiguring net management parameters using state meta data harvested by the heartbeat mechanism from a plurality of TCP/IP networked devices to achieve standardized command and control situational awareness;
b) Use commercial equivalent wizards corresponding to military Unit Task Order UTO tools to (re) configure net management parameters described by a military K00.99 heartbeat message and standardize on a commercial equivalent counterpart heartbeat XML message used by SWIFT, e9-1-1 and military telecommunication standards that are currently non-standard;
c) Use commercial counterparts to military command and control system administrator/network monitoring software wizards, intelligent software agents to configure then send out unit/entity/organization task organization message to set effective time (when order will be executed) via workflow tools via Unicast/Multicast group subscriptions;
d) Apply user selected beacon broadcast technology to distribute (binary) Common Alert protocol XML schemas, child schemas, data islands and/or NIEM payloads within CAP Schemas;
e) Standardize on a common paradigm of establishing pre coordinated date and time when devices in multicast groups reconfigure router Management Information Base MIB configuration descriptions MIBS (common to all routers—military & commercial) then;
f) Use directory (LDAP) subscription lists referral reassigning INC: Internet Controller commercial counterpart net addresses defined by Universal Reference Number URN and or Organizational ID that is not the current practice of commercial, private of Non Governmental Agency NGO's;
g) Use commercial equivalents to military net management applications e.g., ISYSCON, CISCO IPICS/Juniper CESAC to make new multicast group file used to update router MIBs automatically at agreed, standardized, synchronized time intervals;
h) Update Command and Control Registry C2R commercial equivalent i.e., Lightweight Directory Access Protocol LDAP Server multicast MCG update tool updates multicast group data on commercial equivalents to Army Information Management AIS servers);
i) Use a commercial equivalent to the military State Management process on Army Information Server AIS/LDAP directory server to recognize in a standardized manner that a change has occurred sending out change alert throughout the cloud computing/grid networking environment;
j) Use beacon technology (user selected) to broadcast state changes in a universally standard practice endorsed by NIST/ITU (i.e., Microsoft Groove's intrinsic state manager) to replicate updated multicast groups with routing information obtained from LDAP server then configure the Network Interface Card NIC with new IP lease.

3. A method of claim standardizing on the web OASIS Common Alert Protocol XML schema version of the military heartbeat message (K00.99) USMTF/JVMF/TADL proprietary formatted UTO heartbeat message converted to (binary) XML message/document/form/data element XML structures;
a) enable faster than thirty second web portal screen refreshes where eXtensible markup language (XML) wrapper exposes the military discovery metadata to a web portal for screen refresh/updating faster (e.g., milliseconds, seconds) due to direct schema/message/form exchanges and use of beacon protocol and cache technologies;
b) derive and standardize from the military's (K00.99) heartbeat message data entity values/attributes such as: current/active data; IP lease, location, Synchronization Delta Time Block, current Unit Task Organization UTO, UTR (U=Unit, T=Task, R=reorganization) command, Effective Date/Time/Group (DTG) Block, command relationship (OPCON, attach), Unit of Action, Unit of Employment affiliations, Universal Resource Number URN (unique numeric identification number) describing a plurality of devices, systems, and networks;
c) convert and standardize structured military messaging three and four digit code data element FFIRN/FFUDNs into equivalent CAP XML schema tags that commercial product/component/system's intrinsic forms engine parsers, and state management engines can process;
d) As a universal standard, use OASIS Common Alert Protocol CAP equivalent to military's Unit Task Order—UTO heartbeat message describing key meta data state management elements intrinsic to the military template system FBCB2-BFT situational awareness data types: who, what, where, when, how often, out of radio range, turned off, inoperative for maintenance or in a duress condition at the time of the initial or follow on heartbeat timed data collection interval (e.g., stale, straggler, duress, need medical attention, SOS.) for geospatial/gyroscopic equipped networked devices;
e) As a universal standard, reuse structured military messaging data element strategy e.g., organizational ID in counterpart commercial systems enabling more descriptive entity resolution and cohesive organization action in place of individual platform/computing devices to adjust to organizational schemes of maneuver, operation orders;
f) As a universal standard best practice, best procedure, link from subordinate organizations and import to a single, authoritative CAP schema to/from DOD, Service and Agency XML repositories data element tags correlating from civilian systems to military FFIRNs and FFUDN(s) supporting a plurality of international, federal, state, tribal, local user XML tag requirements;
g) As a universal standard, best practice, procedure and method/structure, use the Common Alert Protocol child schema/messages in accordance with National Information Exchange Model NIEM payloads compliant with the Emergency Data Exchange Language Distribution Element EDXL-DE standard that includes the DoD Discovery Metadata Standard DDMS elements as data islands in child schema and/or NIEM payloads to trigger data exchange cascades across disparate stakeholder domains (e.g., .mil, .gov, .edu, .com, .biz, .net, .org.) and Communities of Interest COI described by graphic overlays and synchronization matrixes.

4. A method of claim using beacon broadcast technologies to distribute/replicate state meta-data describing network management unit/organizational structure—affiliations by Organizational ID ORG ID and Universal Resource Number URN, synchronously and timed in a standard, repetitive, predictable manner as a best practice, best procedure, and best method:
a) use the beacon's millisecond—99 minute timing function to establish standard, consistent timing and synchronous state meta-data collection to enable consistent, synchronized collection of raw state meta data (geo location, moving, halt, IP address, unit/organization Universal ID) BEFORE transfer to queues, SANS, dbase . . . PRIOR to data fusion activities to enhance filtering/data intelligence fusion and network forensic analysis functions;
b) To establish a universal standard best practice, assemble heartbeat network reconfiguration messages with embedded data islands, and/or separate small files (situation and scenario dependent) formatted as non military unique binary formats for example, Efficient XML by AgileDelta, Binary Runtime Environment for Wireless BREW by Qualcomm, Fast-Infoset by Sun Microsystems, and other commercial binary XML type formats (WAP, xs:base64Binary and xs:hexBinary,);
c) To establish a universal standard best method, use network state meta data gathered from a plurality of TCP/IP networked devices using heretofore unused opportunities in time/TCP/IP frames are temporarily stored then collected and aggregated by network administrator/S6 operators before redistribution as heartbeat network reconfiguration messages via a plurality of broadcast mechanisms e.g., TDXP, 802.11s ESS, ZigBee IEEE 802.15.4, Z-Wave type wireless mesh networks, Groove bots, JXTA motes, intelligent agents, Cougaar, and beacon protocols such as FLUX, ADS-B Sea Gull, SABRE, Sentinel, SAFECON, Telcordia DAP or Boeing Future Combat System Common Operating Environment COE middleware or Department of Homeland Security Unified Incident Command and Decision Support_UCIDS middleware) across x complex systems, y federal, state and local contracts, and z products, operating system, network and system types;
d) To standardize, enhance and improve current international response mechanisms, apply user selected beacon technology (e.g., Sea Gull, Boston University Beacon Project) to increase/increase geographic radius of disaster/event/alert emulated by multicast zones corresponding to five level advisory systems showing on geospatial displayed symbolically as intensity and threshold conditions;
e) Emulate increasing/decreasing alert/event, levels by router hop-count multicast radius supporting disabled blind and deaf users and for light degraded conditions via audible step tones i.e., NASA's and National Undersea Research Center NURC's tonal based messaging systems reused from space/deep sea operations to establish international standards via National Institute for Standards and Technology NIST and the International Telecommunications Union ITU;
f) To establish international standard best practice, use (military) chop chain/commercial business logic workflows over multicast IP seeded to router MIBs to set up a conditions where National Command Authority alerts and events are instantiated and cascaded from one, single focal instantiation point (i.e., the big red button metaphor) establishing a single umbrella of command, control, and communications;
g) To standardize across systems of similar use and purpose, use e9-1-1 Public Safety Answering Points (PSAP) (inter) national e9-1-1 next generation systems across a plurality of (federal, private, public and Non Governmental Organization) contracts containing telecommunication and situational awareness CDRLs.
